(19) United States
(12) Patent Application Publication
(10) Pub. No.: US 2025/0217181 A1
(43) Pub. Date: Jul. 3, 2025

(54) THERMAL-AWARE INTERRUPT ROUTING IN AN INTERRUPT CONTROLLER IN PROCESSOR-BASED SYSTEMS, AND RELATED METHODS

(71) Applicant: QUALCOMM Incorporated, San Diego, CA (US)

(72) Inventors: Sumit Gemini, Delhi (IN); Naman Jain, Hyderabad (IN); Hithesh Hassan Lepaksha, Hyderabad (IN)

(21) Appl. No.: 18/402,088

(22) Filed: Jan. 2, 2024

(51) Int. Cl. G06F 9/48; G06F 9/50

(52) U.S. Cl. CPC G06F 9/4812; G06F 9/5094

(57) ABSTRACT

Thermal-aware interrupting routing in an interrupt controller in processor-based systems, and related methods are disclosed. The processor-based system includes one or more interrupt controllers that are each configured to prioritize interrupts received from components in the processor-based system and direct each received interrupt to a CPU core(s) in its designated processor to perform an interrupt service routine (ISR) to process the interrupt. To avoid or reduce the likelihood of the interrupt controller directing an interrupt to a CPU core(s) and/or CPU core cluster(s) that may exceed its thermal limit by accepting and handling the interrupt, the interrupt controller is configured to be aware of temperatures of the CPU cores and/or the CPU core clusters in its designated processor. The interrupt controller is configured to selectively route received interrupts based on temperature of the CPU core(s) and/or their CPU core cluster(s) that were determined eligible to receive and handle the interrupt.

### BACKGROUND

### I. Field of the Disclosure

The field of the disclosure relates to a processor-based system that includes one or more processing units, such as a system-on-a-chip (SoC), that includes one or more processors, and more particularly to thermal management of the processors in the processor-based system to avoid exceeding thermal limitations.

### II. Background

Processor-based systems, such as a system-on-a-chip (SoC), include one or more processors and supporting circuitry, such as memory and power management circuits for performing tasks. The SoC is a single semiconductor die that can include multiple processors and different types of processors to perform different types of operations efficiently (e.g., a central processing unit(s) (CPU(s)), a graphic processing unit(s) (GPU(s)), and/or or a neural processing unit(s) (NPU(s))). Each processor can include one or more CPU cores that are organized in clusters of CPU cores. A processor can include a frequency and/or voltage scaling system configured to dynamically change or scale the frequency of clocked circuits and CPU cores and/or their voltage level for operation. A higher frequency results in a faster operation of a clocked circuit. However, a higher voltage level may be required to support operation at a higher frequency. Further, higher frequency and voltage operation results in increased power consumption. An increased amount of heat is generated by the processor(s) and circuits in a processor as a result of energy losses from the powered operation of the circuits therein. However, a processor has a thermal, temperature limitation for operation. This thermal limit may be based on circuit performance criteria (e.g., a circuit will have a thermal limit at which performance starts to decrease), to extend battery life, and/or to maintain temperature within “skin limits.” Ambient temperature also affects the temperature of the processor.

With increases in operating frequencies of processors in processor-based systems (e.g., greater than 5 GigaHertz (GHz)) to achieve increased performance, which in turn requires increased voltage and increased power consumption to support such higher operating frequencies, thermal management becomes increasingly more important. In this regard, a processor can include a thermal management system that includes temperature sensors to sense the temperature in various areas of the processor-based system, including on-die with processors. For example, temperature sensors can be located on-die and associated with CPU cores of a processor to sense the temperature of the CPU cores. The thermal management system can be configured to limit power consumption, and thus excess heat generation, in its processor when a temperature sensor detects a thermal violation. The thermal management system can limit power consumption by reducing operating frequency, idling, or shutting down a CPU core detected to have a thermal violation to in turn reduce power consumption and heat from losses. The need to perform thermal management in a processor may be particularly important when the processor is employed in processor-based systems in environments that have higher ambient temperatures, such as automobile applications. However, reducing the operating frequency can result in reduced performance of not only the CPU core having a thermal violation, but also other clustered CPU cores. This is because CPU cores in a CPU cluster may be clocked with a common clock signal. Also, idling or shutting down a CPU core with a thermal violation may also shut down or idle the other clustered CPU cores. Also, tasks that are scheduled to be performed by a given CPU core that has a thermal violation may have to be scheduled to be performed by another CPU in another CPU cluster, resulting in reduced efficiency in performance.

Some activities in a processor result in more sudden increases in power consumption due to sudden increases in load. For example, operations that involve movement of data from fast memories like cache memory may result in a sudden increase in power consumption causing a thermal violation based on knowledge of scheduled memory transactions as an example. However, there are other unscheduled activities that can occur in processor and/or CPU core that could result in a sudden increase in power consumption before the thermal management system can take action to reduce performance and power consumption. For example, interrupt handling is an unscheduled activity that may involve quick burst of memory transactions for context switching that cannot be precisely scheduled to the handling CPU core without causing a thermal violation.

### SUMMARY OF THE DISCLOSURE

Aspects disclosed herein include thermal-aware interrupting routing in an interrupt controller in processor-based systems. Related methods are also disclosed. The processor-based system (e.g., a system-on-a-chip (SoC)) includes one or more processors that each include a plurality of central processing unit (CPU)/processor cores each configured to execute instructions to perform specific tasks within its processor. The processor-based system includes one or more interrupt controllers that are each configured to prioritize interrupts received from components (e.g., peripherals, memory) in the processor-based system and direct (e.g., broadcast) each received interrupt to a CPU core(s) in its designated processor to perform an interrupt service routine (ISR) to process the interrupt. The interrupt controller is configured to determine which CPU cores in its designated processor are eligible to handle the interrupt based on an interrupt routing policy (e.g., based on factors like power state of the processor, priority, and CPU core availability). In exemplary aspects, to avoid or reduce the likelihood of the interrupt controller directing an interrupt to a CPU core(s) and/or a CPU core cluster(s) that may exceed its thermal limit (e.g., a set or designated temperature threshold) by accepting and handling the interrupt, the interrupt controller is configured to be aware of the temperatures of the CPU cores and/or the CPU core clusters in its designated processor. The interrupt controller is configured to selectively route received interrupts based on the temperature of the eligible CPU core(s) and/or their CPU core cluster(s) determined as eligible to receive and handle the interrupt.

In this regard, in exemplary aspects, the interrupt controller is configured to determine which eligible CPU core(s) and/or CPU core clusters(s) for handling the interrupt can do so without exceeding a thermal limit (e.g., a temperature threshold) based on its current or recent temperature. Interrupt handling involves context switching that can cause sudden and unscheduled increases in power consumption. In this manner, the need to perform thermal mitigation of a CPU core and/or a CPU core cluster as a result of handling interrupts may be avoided or reduced to avoid a reduction in performance from interrupt handling. The interrupt controller can selectively route an interrupt to another eligible CPU core(s) and/or other CPU core cluster(s) that is determined to be able to handle the interrupt without exceeding a thermal limit. Also, in this manner, the CPU cores are not required to be self-aware of their temperature to determine whether to accept a received interrupt to avoid exceeding its thermal limit and/or its CPU core cluster thermal limit.

In other exemplary aspects, the interrupt controller can be configured to receive and store updated temperature data regarding the temperature of the CPU cores and/or the CPU core clusters from temperature sensors that are associated (e.g., in close proximity) with the CPU cores and/or the CPU core clusters. In an example, the interrupt controller is configured to receive the temperature data over a communication bus that is configured to carry temperature data from the temperature sensors. The interrupt controller can be configured to receive and update the temperature data regarding the temperature of the CPU cores and/or the CPU core clusters on a continuous basis or on demand when an interrupt is received that is to be routed. For example, it may be desired for the interrupt controller to be configured to receive and update the temperature data regarding the temperature of the CPU cores and/or the CPU core clusters on a continuous basis to handle latency sensitive interrupts to reduce interrupt routing time. As another example, it may be desired for the interrupt controller to be configured to receive and update the temperature data regarding the temperature of the CPU cores and/or the CPU core clusters on demand, when required and requested, to reduce power consumption from continuously receiving and updating temperature information.

In other exemplary aspects, the interrupt controller may also be configured to be aware of the thermal limits (i.e., a set or designated temperature threshold) of each of the CPU cores and/or the CPU core clusters in its designated processor. For example, some CPU cores and/or CPU core clusters may have different thermal limits depending on their design and whether they are configured to perform specialized versus generalized tasks for the processor. In this manner, the interrupt controller can be configured to determine which eligible CPU core(s) and/or CPU core clusters(s) determined able to handle the interrupt can do so without exceeding its specific thermal limit based on its current or recent temperature and the thermal headroom that exists between the current temperature and its thermal limit. Limiting interrupt handling to a CPU core based on the thermal limit of its CPU core cluster may be advantageous, because if thermal mitigation is required, the thermal mitigation may reduce the performance of all the CPU cores in the CPU core cluster based on the CPU core cluster sharing resources, such as being clocked off a common clock signal.

Also, the temperature of CPU cores can be highly affected by the temperature of a neighboring CPU core in the same CPU core cluster. Thus, in other exemplary aspects, the interrupt controller can be further configured to determine to which CPU core(s) of the determined eligible CPU core(s) and/or CPU core cluster(s) to route an interrupt based determined eligible CPU core(s) and/or CPU core cluster(s) not only not exceeding its thermal limit based on handling the interrupt, but also other surrounding CPU cores (e.g., in close proximity and/or in the same CPU core cluster) being determined to not exceed their thermal limits based on their temperatures and/or also the temperature impact from a surrounding CPU core accepting and handling the interrupt. The interrupt controller can be configured to have knowledge of the identity of the CPU cores that are surrounding each CPU core and also use the knowledge of the temperatures and/or thermal limits of the surrounding CPU cores to determine if an interrupt handled by a given CPU core will cause any surrounding CPU core to exceed its thermal limit and/or the CPU core cluster thermal limit. In this manner, the interrupt controller serves to guard surrounding CPU cores from exceeding their thermal limits that may result in directing an interrupt to a CPU core surrounded by the surrounding CPU cores. In another exemplary aspect, the interrupt controller can be also configured to route interrupts to an eligible CPU core(s) and/or a CPU core cluster(s) that would not cause the overall thermal limit for the processor and/or processor-based system to be exceeded.

In other exemplary aspects, the interrupt controller includes a temperature capture circuit and a temperature-aware routing circuit, which may be purely combinational logic (e.g., gates) and memory circuits (e.g., latches, flip-flops) as a non-limiting example. The temperature capture circuit is configured to capture temperature data regarding the temperature of the CPU cores and/or the CPU core clusters in its designated processor, and like the examples described above. The temperature-aware routing circuit is configured to not only route interrupts to a CPU core(s) and/or a CPU core cluster(s) based on prioritization aspects, but also on the temperature of the CPU cores and/or the CPU core clusters in its designated processor, and like the examples described above. The interrupt controller can also include a control unit circuit that is configured to be programmed (at manufacture and/or during operation) with routing control information for the thermal limit at the CPU core cluster level, the acceptable thermal margin of the CPU cores and/or the CPU core clusters, and the temperature coupling effect on neighboring CPU cores. The temperature coupling effect on neighboring CPU cores may have been predetermined based on measuring the temperature increase among surrounding CPU cores based on activity of a particular CPU core. The routing control information can be used by the temperature-aware routing circuit along with the temperature data captured in the temperature capture circuit to determine the routing of interrupts to a CPU core(s) and/or a CPU core cluster(s).

In this regard, in one exemplary aspect, an interrupt controller in a processor-based system. The interrupt controller is configured to receive temperature data related to a temperature for a plurality of CPU cores in a processor in the processor-based system. The interrupt controller is also configured to receive an interrupt in the processor-based system. The interrupt controller is also configured to determine one or more eligible CPU cores of the plurality of CPU cores eligible to handle the interrupt based on an interrupt routing policy. The interrupt controller is also configured determine, based on the temperature data, a first set of eligible CPU cores of the one or more eligible CPU cores that would remain below a temperature threshold based on handling the interrupt. The interrupt controller is also configured communicate the interrupt to be received by the first set of eligible CPU cores.

In another exemplary aspect, a method of routing interrupts to central processing unit (CPU) cores in a processor. The method comprises receiving temperature data related to a temperature for a plurality of CPU cores in a processor in a processor-based system. The method also comprises receiving an interrupt in the processor-based system. The method also comprises determining one or more eligible CPU cores of the plurality of CPU cores eligible to handle the interrupt based on an interrupt routing policy. The method also comprises determining, based on the temperature data, a first set of eligible CPU cores of the one or more eligible CPU cores that would remain below a temperature threshold based on handling the interrupt. The method also comprises communicating the interrupt to be received by the first set of eligible CPU cores.

In another exemplary aspect, a processor-based system is provided. The processor-based system comprises a plurality of interrupt generating devices each configured to generate an interrupt. The processor-based system also comprises a first processor comprising a plurality of first CPU cores, and a first interrupt controller. The first interrupt controller is configured to receive first temperature data related to a temperature for the plurality of first CPU cores from one or more temperature sensors; receive a first interrupt from an interrupt generating device of the plurality of interrupt generating devices; determine one or more first eligible CPU cores of the plurality of first CPU cores eligible to handle the first interrupt based on a first interrupt routing policy; determine, based on the first temperature data, a first set of eligible CPU cores of the one or more first eligible CPU cores that would remain below a first temperature threshold based on handling the first interrupt; and communicate the first interrupt to be received by the first set of eligible CPU cores. Each first eligible CPU core of the first set of eligible CPU cores is configured to receive the first interrupt; determine whether to service the first interrupt; and in response to determining to service the first interrupt, service the first interrupt.

### BRIEF DESCRIPTION OF THE FIGURES

FIG. 1 is a block diagram of an exemplary processor-based system that includes multiple processors each with a plurality of central-processing unit (CPU) cores that can be clustered in CPU core clusters, and interrupt routing circuits each associated with a designated processor to route interrupts to the processor for interrupt servicing, wherein an interrupt controller(s) is configured to selectively route received interrupts to a CPU core(s) in its designated processor determined to be eligible to handle the interrupt, and based on determining from temperature data which CPU cores(s) of the eligible CPU core(s) would remain below its thermal limit and/or its CPU core cluster thermal limit from handling the interrupt;

FIG. 2 is a block diagram of an exemplary interrupt controller and designated processor in the processor-based system in FIG. 1;

FIG. 3 is a flowchart illustrating an exemplary process that can be performed by the interrupt controller in FIG. 2, wherein the exemplary process includes receiving temperature data for CPU cores in a processor and selectively routing a received interrupt to one or more eligible CPU cores that are also determined, based on the temperature data from the one or more CPU cores, to remain below its thermal limit from handing the interrupt;

FIG. 4 is a block diagram of an exemplary interrupt controller and designated processor that can be provided in the processor-based system in FIGS. 1 and 2, wherein the interrupt controller is configured to selectively route received interrupts to a CPU core(s) in its designated processor determined to be eligible to handle the interrupt, and based on determining from temperature data which CPU cores(s) of the eligible CPU core(s) would remain below its thermal limit and/or its CPU core cluster thermal limit from handling the interrupt;

FIG. 5 is a table illustrating exemplary routing control information that can be provided in a control unit circuit in the interrupt controller in FIG. 4, wherein the routing control information includes temperature thresholds for the CPU cores and/or their CPU core clusters and is accessible to the interrupt controller to selectively route received interrupts based on routing control information to determine an eligible CPU core(s) to handle the received interrupt and based on the temperature threshold of the eligible CPU core(s) and/or their CPU core cluster as compared to their temperatures;

FIG. 6A is a flowchart illustrating an exemplary process that can be performed by the interrupt controller in FIGS. 1-2 and 4, wherein the exemplary process includes receiving temperature data for CPU cores in a processor and selectively routing a received interrupt to one or more eligible CPU cores that are also determined, based temperature data from the one or more CPU cores, to remain below its thermal limit from handing the interrupt;

FIG. 6B is a flowchart illustrating an exemplary process that can be performed by the interrupt controllers in FIGS. 1-2 and 4, wherein the exemplary process includes receiving temperature data for CPU cores in a processor and selectively routing a received interrupt to one or more eligible CPU cores that would cause its CPU core cluster to remain below its thermal limit if the one or more eligible CPU cores handled the interrupt;

FIG. 6C is a flowchart illustrating an exemplary process that can be performed by the interrupt controller in FIGS. 1-2 and 4, wherein the exemplary process includes receiving temperature data for CPU cores in a processor and selectively routing a received interrupt to one or more eligible CPU cores that are also determined, based on temperature data for an eligible CPU core and other CPU cores in designated proximity to the eligible CPU core, for the eligible CPU core to remain below its thermal limit from handing the interrupt;

FIG. 7 is a block diagram of an exemplary processor-based system that includes one or more processors and one or more interrupt controllers including, but not limited to, the interrupt controller in FIGS. 1-2 and 4, designated for a processor and configured to receive temperature data for CPU cores in a processor and selectively route received interrupts based on routing control information to determine an eligible CPU core(s) to handle the received interrupt and based on the temperature threshold of the eligible CPU core(s) and/or their CPU core cluster as compared to their temperatures, and according to, but not limited to, the processes in FIGS. 3 and 6A-6C; and

FIG. 8 is a block diagram of an exemplary wireless communications device that includes radio-frequency (RF) components that can include a processor-based system that includes one or more processors and one or more interrupt controllers including, but not limited to, the interrupt controller in FIGS. 1-2 and 4, designated for a processor and configured to receive temperature data for CPU cores in a processor and selectively route received interrupts based on routing control information to determine an eligible CPU core(s) to handle the received interrupt and based on the temperature threshold of the eligible CPU core(s) and/or their CPU core cluster as compared to their temperatures, and according to, but not limited to, the processes in FIGS. 3 and 6A-6C.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed herein include thermal-aware interrupting routing in an interrupt controller in processor-based systems. Related methods are also disclosed. The processor-based system (e.g., a system-on-a-chip (SoC)) includes one or more processors that each include a plurality of central processor unit (CPU)/processor cores each configured to execution instructions to perform specific tasks within its processor. The processor-based system includes one or more interrupt controllers that are each configured to prioritize interrupts received from components (e.g., peripherals, memory) in the processor-based system and direct (e.g., broadcast) each received interrupt to a CPU core(s) in its designated processor to perform an interrupt service routine (ISR) to process the interrupt. The interrupt controller is configured to determine which CPU cores in its designated processor are eligible to handle the interrupt based on an interrupt routing policy (e.g., based on factors like power state of processor, priority, and CPU core availability). In exemplary aspects, to avoid or reduce the likelihood of the interrupt controller directing an interrupt to a CPU core(s) and/or a CPU core cluster(s) that may exceed its thermal limit (e.g., a set or designated temperature threshold) by accepting and handling the interrupt, the interrupt controller is configured to be aware of the temperatures of the CPU cores and/or the CPU core clusters in its designated processor. The interrupt controller is configured to selectively route received interrupts based on the temperature of the eligible CPU core(s) and/or their CPU core cluster(s) determined as eligible to receive and handle the interrupt.

In this regard, in exemplary aspects, the interrupt controller is configured to determine which eligible CPU core(s) and/or CPU core clusters(s) for handling the interrupt can do so without exceeding a thermal limit (e.g., a temperature threshold) based on its current or recent temperature. Interrupt handling involves context switching that can cause sudden and unscheduled increases in power consumption. In this manner, the need to perform thermal mitigation of a CPU core and/or a CPU core cluster as a result of handling interrupts may be avoided or reduced to avoid a reduction in performance from interrupt handling. The interrupt controller can selectively route an interrupt to another CPU core(s) and/or other CPU core cluster(s) that is determined to be able to handle the interrupt without exceeding a thermal limit. Also, in this manner, the CPU cores are not required to be self-aware of their temperature to determine whether to accept a received interrupt to avoid exceeding its thermal limit and/or its CPU core cluster thermal limit.

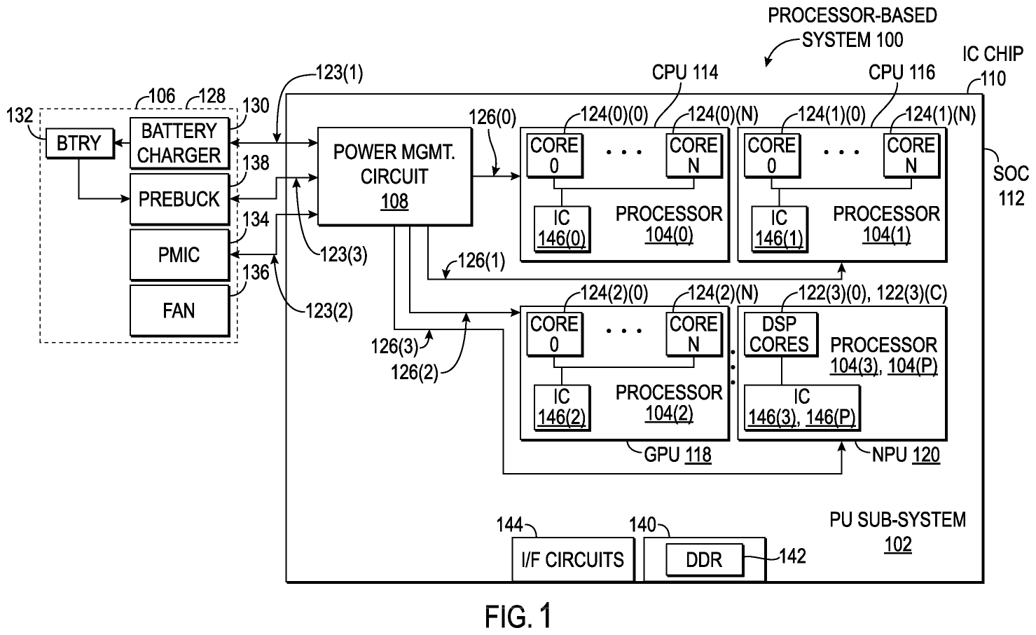

In this regard, FIG. 1 is a block diagram of an exemplary processor-based system 100 that includes a processing unit (PU) sub-system 102 with multiple or ‘P+1’ number of processors 104(0)-104(P), non-processor devices 106, and a power management circuit 108. Before discussing the aspects of the processor-based system 100 in FIG. 1 being able to perform thermal-aware interrupting routing, other exemplary components of the processor-based system 100 are first discussed below.

In this regard, as shown in FIG. 1, the processor-based system 100 includes an integrated circuit (IC) chip 110 in this example, which is a system-on-a-chip (SoC) 112 in this example. The SoC 112 in this example includes the four (4) processors 104(0)-104(3), which in this example are a first central processing unit (CPU) 114, a second CPU 116, a graphics processing unit (GPU) 118, and a neural processing unit (NPU) 120. The processors 104(0)-104(3) are each configured to execute instructions to perform respective workloads. In this example, each of the processors 104(0)-104(3) can include multiple respective processor cores 124(0)(1)-124(0)(N), 124(1)(0)-124(1)(N), 124(2)(0)-124(2)(N), 124(3)(1)-124(3)(C) that are each configured to be assigned or schedule a task to be performed via execution of computer instructions in its respective processor 104(0)-104(3) to perform a task.

With continuing reference to FIG. 1, the power management circuit 108 in the processor-based system 100 is configured to manage power 123(1)-123(3) received from power sources as non-processor devices 128 and to supply power 126(0)-126(3) to the processors 104(0)-104(3) for their operation. These other devices are outside the SoC 112 and its processors 104(0)-104(P) and are also electrical devices that are also power consuming in their own right. In this example, the processor-based system 100 includes a battery charging circuit 130 that is a circuit configured to charge a battery 132. The battery 132 is provided to supply power 123(1) to the processor-based system 100 if the processor-based system 100 is not connected to a fixed power source. In this manner, the processor-based system 100 is configured to operate off of battery power as a power cordless device, such as in a mobile device. As also shown in FIG. 1, the processor-based system 100 includes a power management IC (PMIC) 134 that is configured to manage the supply of power 123(2) to the SoC 112 and other components of the processor-based system 100, such as a fan 136 for cooling. The PMIC 134 manages the battery charging circuit 130 to charge the battery 132 when the processor-based system 100 is connected to a power source. The PMIC 134 manages the discharge of the battery 132 to provide power when the processor-based system 100 is not connected to a power source. The processor-based system 100 in this example also includes a pre-buck power circuit 138 that is configured to supply power 123(3) to the SoC 112 for peak current demands.

With continuing reference to FIG. 1, the processor-based system 100 and SoC 112 in this example also include a shared memory system 140 that can be accessed by each of the processors 104(1)-104(3) for storage and retrieval of data for executing instructions. The shared memory system 140 may be a cache memory, such as a last-level cache memory, as examples. The shared memory system 140 in this example has a shared memory 142 (e.g., a double-data rate (DDR) memory) that is generally accessible by each of the processors 104(0)-104(3). The shared memory system 140 may also have a memory management unit (MMU) configured to manage access to the shared memory system 140. The shared memory system 140 may also have statically configured memory regions for the respective processors 104(1)-104(3) in the SoC 112. The processor-based system 100 also includes interface (I/F) circuits 144 that provide communication interfacing between the processor-based system 100 and its processors 104(0)-104(3) and other devices outside of the processor-based system 100.

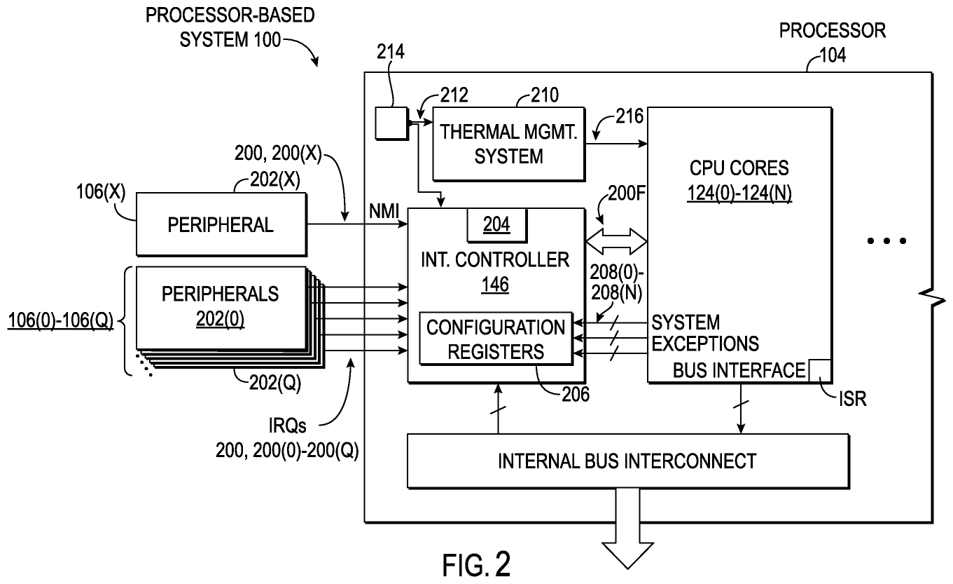

As also shown in the processor-based system 100 in FIG. 1, in this example, each of the processors 104(0)-104(3), 104(P) includes a respective interrupt controller 146(0)-146(3), 146(P). The interrupt controllers 146(0)-146(P) are each configured to receive interrupt requests, also known simply as “interrupts,” from other devices in the processor-based system 100 as a signal to indicate to the processors 104(0)-104(3), 104(P) that such an unscheduled event needs to be processed in a timely manner. This is also shown in more exemplary detail in the processor-based system 100 in FIG. 2, which shows a processor 104, that can be any of the processors 104(0)-104(P) illustrated in FIG. 1. As shown in FIG. 2, the processor 104 includes the interrupt controller 146, which is configured to receive interrupts 200, 200(0)-200(Q) in the form of interrupt requests (IRQs) from non-processor devices 106(0)-106(Q), which are shown as peripherals 202(0)-202(Q). The interrupt controller 146 in FIG. 2 can be any of the interrupt controllers 146(0)-146(P) in the processor-based system 100 in FIG. 1, and could be a generical interrupt controller such as compatible with an ARM architecture as an example. In this example, the interrupt controller 146 is also configured to receive a non-maskable interrupt (NMI) 200, 200(X) from another non-processor device 106(X), which is shown as peripheral 202(X). The interrupt controller 146 in FIG. 2 is only shown as interfacing with multiple CPU cores 124(0)-124(N) like shown in the processors 104(0)-104(P) in FIG. 1. A CPU core is also known as a “processor core.” A CPU core is a processing unit within a CPU or processor that can execute instructions. A processor having multiple CPU cores allows the CPU cores to individually execute instructions to concurrently perform tasks.

The interrupt controller 146 as shown in FIG. 2 is configured to determine, based on an interrupt routing policy 204, which CPU cores 124(0)-124(N) are eligible as “eligible” CPU cores 124(0)-124(N) to receive the interrupt 200(0)-200(Q), 200(X) as a forwarded interrupt 200F to be handled via an interrupt service routine (ISR). The interrupt routing policy 204 may be based on various factors, such as the power state of the processor 104 and/or its CPU cores 124, whether certain CPU cores 124 are designated to perform special tasks (e.g., floating point computations, digital signal processing) called for by the interrupt 200(0)-200(Q), 200(X), the priority of the interrupt 200(0)-200(Q), 200(X), and/or CPU core 124 availability for handling the interrupt 200(0)-200(Q), 200(X), as non-limiting examples. The interrupt controller 146 may use information about the CPU cores 124(0)-124(N) and/or other information stored in configuration registers 206 to implement the interrupt routing policy 204 for routing received interrupts 200(0)-200(Q), 200(X) to the CPU cores 124(0)-124(N). The CPU cores 124(0)-124(N) may be configured to determine if a received interrupt 200F will be accepted and handled, with such indication communicated as a respective signal 208(0)-208 (N) back to the interrupt controller 146.

With continuing reference to the processor-based system 100 and its exemplary processor 108 in FIG. 2, some activities in the processor 104 result in more sudden increases in its power consumption due to sudden increases in load. For example, operations that involve movement of data from fast memories like cache memory may result in a sudden increase in power consumption causing a thermal violation based on knowledge of scheduled memory transactions as an example. However, other unscheduled activities like handling interrupts 200F that can occur in the processor 104 and its CPU cores 124(0)-124(N) could result in a sudden increase in power consumption before a thermal management system 210 that may be provided in the processor 104 can take action to reduce performance and power consumption. For example, interrupt 200F handling is an unscheduled activity that may involve a quick burst of memory transactions for context switching that cannot be precisely scheduled to the handling CPU core 124(0)-124(Q) without causing a thermal violation. In this regard, the thermal management system 210 may be configured to receive temperature data 212 from one or more temperature sensors 214 that are located in the processor 104 (e.g., on-die with the processor 104) in proximity to the CPU cores 124(0)-124(N) and/or in close proximity to the processor 104. The thermal management system 210 can be configured to determine if the processor 104 and/or its CPU cores 124(0)-124(N) are of a temperature exceeding their thermal limit (e.g., a temperature threshold), and in turn issue a control signal 216 to adjust the operating frequency of a clock signal(s) used to clock the processor 104 and/or its individual CPU cores 124(0)-124(N) based on such determination as frequency scaling. For example, operating frequency can be scaled down to reduce power consumption and performance, and thus heat generated by the processor 104. Operating frequency can be scaled up to increase power consumption and performance when enough temperature headroom is available for operation below thermal limits. The thermal management system 210 can also be configured to scale power level (e.g., voltage) up and down as well to increase and decrease power consumption to thermally manage the processor 104 and/or its CPU cores 124(0)-124(N) to provide voltage scaling.

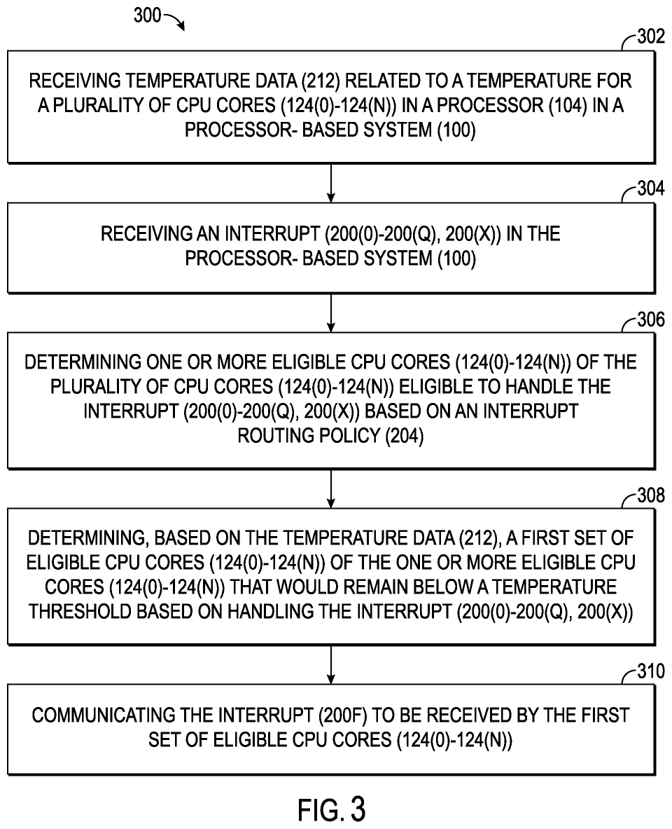

As discussed in more detail below, in examples disclosed herein, the interrupt controller 146 is configured to be aware of the temperatures of the CPU cores 124(0)-124(N) and/or their CPU core clusters in its designated processor 104. In this regard, the interrupt controller 146 is configured to perform a process 300 as shown in FIG. 3 to selectively route the received interrupts 200(0)-200(Q), 200(X) as forward interrupts 200F to the eligible CPU cores 124(0)-124(N) based on the interrupt routing policy 204, based on the CPU cores 124(0)-124(N) being determined to remain below a temperature threshold based on their handling (i.e. if they were to handle) the forwarded interrupt 200F. In this regard, as shown in FIG. 2 and in reference to the process 300 in FIG. 3, the interrupt controller 146 in this example is configured to receive the temperature data 212 from the temperature sensors 214 relating to a temperature of the CPU cores 124(0)-124(N) in the processor 104 of the processor-based system 100 (block 302 in FIG. 3). The interrupt controller 146 is also configured to receive an interrupt 200(0)-200(Q), 200(X)(block 304 in FIG. 3). The interrupt controller 146 is configured to determine one or more eligible CPU cores 124(0)-124(2) from the CPU cores 124(0)-124(N) deemed eligible to handle the received interrupt 200(0)-200(Q), 200(X) based on the interrupt routing policy 204 (block 306 in FIG. 3). The interrupt controller 146 is then configured to determine, based on the temperature data 212 relating to the processor 104 and/or the CPU cores 124(0)-124(N), a first set of eligible CPU cores 124(0)-124(N) that would remain below a temperature threshold based on handling the received interrupt 200(0)-200(Q), 200(X) if forwarded to the eligible CPU cores 124(0)-124(N) as the forwarded interrupt 200F (block 308 in FIG. 3). The interrupt controller 146 is then configured to selectively route the received interrupt 200(0)-200(Q), 200(X) as interrupt 200F to communicate the interrupt 200F to be received by the first set of eligible CPU cores 124(0)-124(N) determined to remain below the temperature threshold based on handling the received interrupt 200F (block 310 in FIG. 3). This can avoid or reduce the likelihood of the interrupt controller 146 directing received interrupts 200(0)-200(Q), 200(X) to a CPU core 124(0)-124(N) that may exceed its thermal limit (e.g., a set or designated temperature threshold) by accepting and handling the forwarded interrupt 200F.

As discussed in examples below, the interrupt controller 146 is configured to determine which eligible CPU cores 124(0)-124(N) and/or clusters(s) for handling the interrupt 200F can do so without exceeding a temperature threshold based on its current or recent temperature relating to the processor 104 and/or the CPU cores 124(0)-124(N) based on the temperature data 212. The interrupt controller 146 can be configured to derive the temperature of the eligible CPU cores 124(0)-124(N) based on the temperature data 212 to anticipate or predict if such eligible CPU cores 124(0)-124(N) would exceed the threshold temperature if they handled the interrupt 204F. If so, the interrupt controller 146 can be configured to not communicate the interrupt 200F to any of the eligible CPU cores 124(0)-124(N) deemed to exceed a threshold temperature by handling the interrupt 200F. The interrupt controller 146 can be configured to communicate the interrupt 200F (or cause the interrupt 200F to be communicated) to only the set of eligible CPU cores 124(0)-124(N) that are deemed to remain below the temperature threshold based on their handling of the interrupt 200F. As discussed below, the interrupt controller 146 may be designed or programmed with global threshold temperatures for each of the CPU cores 124(0)-124(N), or a specific threshold temperature for the different CPU cores 124(0)-124(N).

In this manner, the need for the thermal management system 210 to perform thermal mitigation in the processor 104 and/or for a CPU core 124(0)-124(N) as a result of handling interrupts 204F may be avoided or reduced to avoid a reduction in performance from interrupt handling. The interrupt controller 146 can selectively route an interrupt 200(0)-200(Q), 200(X) as a forwarded interrupt 200F to another eligible CPU core 124(0)-124(N)(based on the interrupt routing policy 204) in the set of eligible CPU cores 124(0)-124(N) that is determined to be able to handle the interrupt 200F without exceeding a thermal limit. Also, in this manner, the CPU cores 124(0)-124(N) are not required to be self-aware of their temperature and/or thermal limit to determine whether to accept a received interrupt 200F to avoid exceeding its thermal limit.

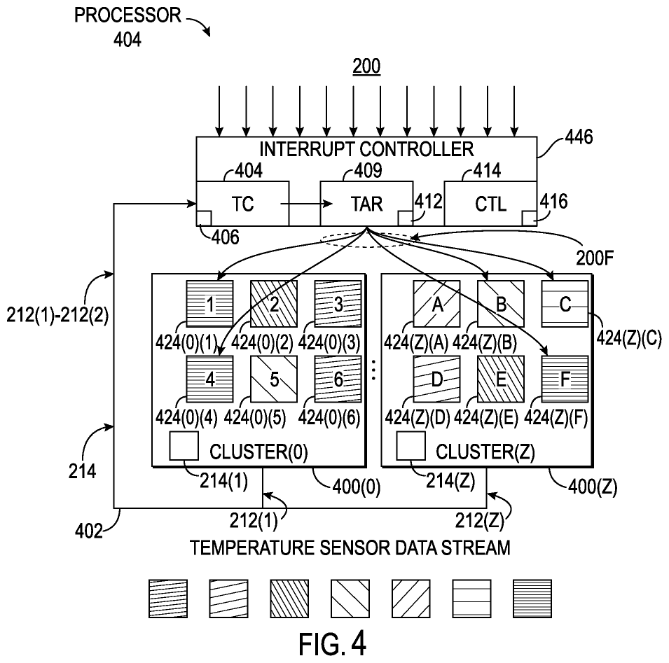

FIG. 4 is a block diagram of another exemplary processor 404 that includes another exemplary interrupt controller 446 that is also configured to selectively route received interrupts to set of eligible CPU core(s) determined to be eligible to handle the interrupt, and based on the CPU core(s) remaining within its thermal limit from handling the interrupt. The processor 404 can be a processor 104(0)-104(P) in the processor-based system 100 in FIG. 1. The interrupt controller 446 can be an interrupt controller 146 in the processor-based system 100 in FIG. 1. As illustrated in FIG. 4, in this exemplary, the processor 404 includes multiple CPU core clusters 400(0)-400(Z) that each include six (6) respective CPU cores 424(0)(1)-424(0)(6)-424(Z)(A)-424(Z)(F). A CPU core cluster is a group of CPU cores that are either tightly or loosely coupled to each other through a communication network as nodes such that the CPU cores in a given CPU core cluster can work together and act as a single entity to perform a task or their CPU cores act individually as individual CPU cores to perform individual tasks. Even though the CPU cores 424(0)(1)-424(0)(6)-424(Z)(A)-424(Z)(F) are clustered in the respective CPU core clusters 400(0)-400(Z), each of the CPU core clusters 400(0)-400(Z) may be separately identifiable and accessible within the processor 404 and individually selectable as eligible CPU cores 424(0)-424(Z) to receive a forwarded interrupt 200F from a received interrupt 200 for handling.

As shown in FIG. 4, in this example, a temperature sensor 214(1)-214(Z) is associated with each CPU core cluster 400(0)-400(Z) and in close proximity to the CPU cores 424(0)(1)-424(0)(6)-424(Z)(A)-424(Z)(F) in their respective CPU core cluster 400(0)-400(Z). The temperature of a CPU cores 424(0)(1)-424(0)(6)-424(Z)(A)-424(Z)(F) can be estimated or derived using temperature data 212(1)-212(Z) sensed by a given temperature sensor 214(1)-214(Z) and can be correlated based on the known location of the temperature sensor 214(1)-214(Z) relative to the CPU cores 424(0)(1)-424(0)(6)-424(Z)(A)-424(Z)(F) in close proximity. The temperature sensors 214(1)-214(Z) are configured to provide their respective temperature data 212(1)-212(Z) onto an internal communication bus 402 that is coupled to the interrupt controller 446. Note that in one example, the interrupt controller 446 can be configured to continuously and/or periodically on a schedule poll the communication bus 402 to receive the temperature data 212(1)-212(Z) irrespective of the timing of a receipt of an interrupt 200. In this manner, the temperature data 212(1)-212(Z) is readily available to use to route latency sensitive interrupts to reduce interrupt routing time of an interrupt 200 to an eligible CPU core 424(0)(1)-424(0)(6)-424(Z)(A)-424(Z)(F) and/or the CPU core cluster 400(0)-400(Z). In another example, the interrupt controller 446 can be configured to poll the communication bus 402 to receive the temperature data 212(1)-212(Z) on demand as requested. This may be advantageous to avoid the interrupt controller 146 consuming power in receiving temperature data 212(1)-212(Z) when an interrupt 200 is not currently present to be routed. However, the temperature data 212(1)-212(Z) will not already be available for processing, which may delay the routing of the interrupt 200.

With continuing reference to FIG. 4, the interrupt controller 446 in this example includes a temperature capture circuit 408. The temperature capture circuit 408 is configured to receive and store the temperature data 212(1)-212(Z) from the communication bus 402 to be used by the interrupt controller 446 for determining whether an eligible CPU core 424(0)(1)-424(0)(6)-424(Z)(A)-424(Z)(F) and/or the CPU core cluster 400(0)-400(Z) can remain within a threshold temperature before routing a received interrupt 200 to the eligible CPU core 424(0)(1)-424(0)(6)-424(Z)(A)-424(Z)(F) and/or the CPU core cluster 400(0)-400(Z). As an example, the temperature capture circuit 408 may include registers 406 that are configured to store the temperature data 212(1)-212(Z). The interrupt controller 446 in this example also includes a temperature-aware routing circuit 409. The temperature-aware routing circuit 409 is configured to determine the eligible CPU core 424(0)(1)-424(0)(6)-424(Z)(A)-424(Z)(F) and/or the CPU core cluster 400(0)-400(Z) based on an interrupt routing policy 412. The temperature-aware routing circuit 409 is also configured to determine, based on the temperature data 212(1)-212(Z), if the eligible CPU core 424(0)(1)-424(0)(6)-424(Z)(A)-424(Z)(F) and/or the CPU core cluster 400(0)-400(Z) will remain below a threshold temperature if the eligible CPU core 424(0)(1)-424(0)(6)-424(Z)(A)-424(Z)(F) and/or the CPU core cluster 400(0)-400(Z) were to handle the received interrupt 200 as a forwarded interrupt 200F. If so, the temperature-aware routing circuit 409 will communicating the interrupt 200F to the set of eligible CPU cores 424(0)(1)-424(0)(6)-424(Z)(A)-424(Z)(F) and/or the CPU core cluster 400(0)-400(Z) that were determined to remain below a threshold temperature if handling the interrupt 200F. If not, the temperature-aware routing circuit 409 will exclude communicating the interrupt 200F to the otherwise eligible CPU core 424(0)(1)-424(0)(6)-424(Z)(A)-424(Z)(F) and/or the CPU core cluster 400(0)-400(Z).

With continuing reference to FIG. 4, the interrupt controller 146 in this example also includes a control unit circuit 414. The control unit circuit 414 includes a thermal register 416 configured to store one or more threshold temperatures or other related data for the CPU cores 424(0)(1)-424(0)(6)-424(Z)(A)-424(Z)(F) and/or the CPU core cluster 400(0)-400(Z) that can be accessed and used by the temperature-aware routing circuit 409 to route received interrupts 200 to derive thermal information about the CPU cores 424(0)(1)-424(0)(6)-424(Z)(A)-424(Z)(F) and/or the CPU core cluster 400(0)-400(Z). This threshold temperature can be compared to the temperature data 212(1)-212(Z) related to an eligible CPU core 424(0)(1)-424(0)(6)-424(Z)(A)-424(Z)(F) and/or the CPU core cluster 400(0)-400(Z) to determine if an eligible CPU core 424(0)(1)-424(0)(6)-424(Z)(A)-424(Z)(F) and/or the CPU core cluster 400(0)-400(Z) will remain below a threshold temperature if the eligible CPU core 424(0)(1)-424(0)(6)-424(Z)(A)-424(Z)(F) and/or the CPU core cluster 400(0)-400(Z) were to handle the received interrupt 200 as a forwarded interrupt 200F based on its temperature from the temperature data 212(1)-212(Z).

In one example, the temperature threshold may be a maximum temperature threshold that the CPU cores 424(0)(1)-424(0)(6)-424(Z)(A)-424(Z)(F) and/or the CPU core clusters 400(0)-400(Z) can sustain to either not degrade performance in an undesired manner and/or be inoperable. In another example, a single temperature threshold is stored in the thermal register 416 and used for each of the CPU cores 424(0)(1)-424(0)(6)-424(Z)(A)-424(Z)(F) and/or the CPU core clusters 400(0)-400(Z). In another example, multiple temperature thresholds are stored in the thermal register 416 and used for the CPU cores 424(0)(1)-424(0)(6)-424(Z)(A)-424(Z)(F) and/or the CPU core clusters 400(0)-400(Z) so that each CPU cores 424(0)(1)-424(0)(6)-424(Z)(A)-424(Z)(F) and/or the CPU core clusters 400(0)-400(Z) has its specific temperature threshold. For example, different CPU cores 424(0)(1)-424(0)(6)-424(Z)(A)-424(Z)(F) and/or the CPU core clusters 400(0)-400(Z) may have different thermal limits depending on their design and function, and whether they are configured to perform specialized versus generalized tasks for the processor 404. As will be discussed in more detail below, the thermal register 416 can also be configured to store other data or settings regarding the CPU cores 424(0)(1)-424(0)(6)-424(Z)(A)-424(Z)(F) and/or the CPU core clusters 400(0)-400(Z) that can be used to determine if an eligible CPU core 424(0)(1)-424(0)(6)-424(Z)(A)-424(Z)(F) and/or the CPU core cluster 400(0)-400(Z) were to handle the received interrupt 200 as a forwarded interrupt 200F.

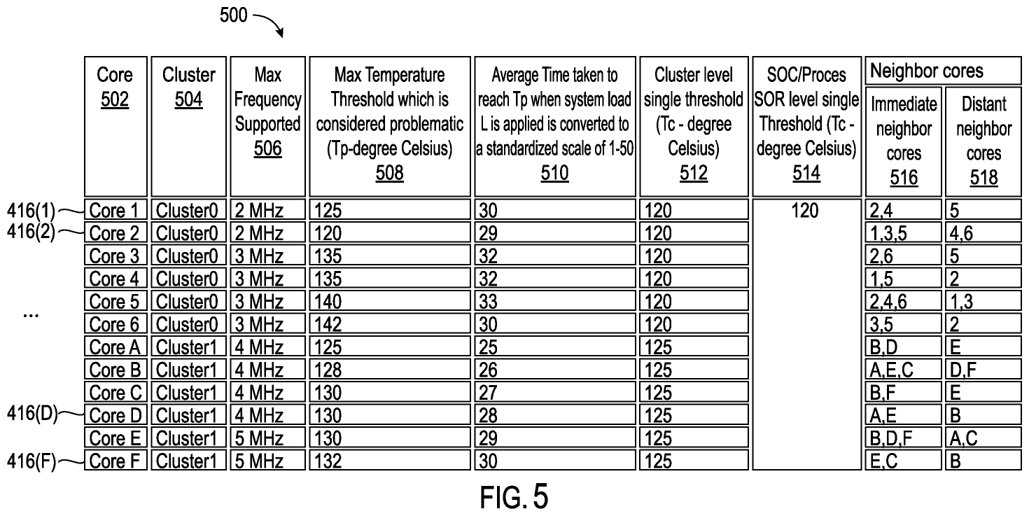

FIG. 5 is a table 500 illustrating exemplary routing control information stored in thermal registers 416(1)-416(F) that are associated with each CPU core 424(0)(1)-424(0)(6)-424(Z)(A)-424(Z)(F) in the processor 404 in FIG. 4. The table 500 is used to explain additional exemplary detail on thermal information that can be used to determine the thermal conditions of the CPU cores 424(0)(1)-424(0)(6)-424(Z)(A)-424(Z)(F) and/or the CPU core clusters 400(0)-400(Z) based on the temperature data 212(1)-212(Z). The thermal conditions of the CPU cores 424(0)(1)-424(0)(6)-424(Z)(A)-424(Z)(F) and/or the CPU core clusters 400(0)-400(Z) can then be used to determine if an eligible CPU core 424(0)(1)-424(0)(6)-424(Z)(A)-424(Z)(F) and/or the CPU core cluster 400(0)-400(Z) were to handle the received interrupt 200 as a forwarded interrupt 200F.

In this regard, as illustrated in FIG. 5, each thermal register 416(1)-416(F) has a core field 502 that identifies the CPU core 424(0)(1)-424(0)(6)-424(Z)(A)-424(Z)(F). Each thermal register 416(1)-416(F) has a cluster field 504 that identifies the CPU core cluster 400(0)-400(Z) in which the CPU core 424(0)(1)-424(0)(6)-424(Z)(A)-424(Z)(F) is provided. In this example, the CPU cores 424(0)(1)-424(0)(6)-424(Z)(A)-424(Z)(F) are either in CPU cluster 0 400(1) or CPU cluster Z 400(Z). Each thermal register 416(1)-416(F) also has a maximum frequency supported field 506 that contains the maximum operating frequency supported by a respective CPU core 424(0)(1)-424(0)(6)-424(Z)(A)-424(Z)(F). Each thermal register 416(1)-416(F) also has a maximum temperature threshold field 508 that contains the maximum temperature for a respective CPU core 424(0)(1)-424(0)(6)-424(Z)(A)-424(Z)(F). Each thermal register 416(1)-416(F) also has a temperature time field 510 that contains an average temperature time taken to reach the respective threshold temperature in the individual temperature threshold field 508 for a respective CPU core 424(0)(1)-424(0)(6)-424(Z)(A)-424(Z)(F) when a given execution load is executed by the CPU core 424(0)(1)-424(0)(6)-424(Z)(A)-424(Z)(F), which is converted to a standardized scale (e.g., 1-50). Each thermal register 416(1)-416(F) also has a cluster threshold temperature field 512 that provides a threshold temperature for each CPU core cluster 400(0)-400(Z) if interrupt routing decisions are being made for eligible CPU core 424(0)(1)-424(0)(6)-424(Z)(A)-424(Z)(F)-424(Z)(A)-424(Z)(F) based on their inclusion in a given CPU core cluster 400(0)-400(Z). Each thermal register 416(1)-416(F) also has a global threshold temperature field 514 that contains a single threshold that cannot be exceeded by any CPU core 424(0)(1)-424(0)(6)-424(Z)(A)-424(Z)(F)-424(Z)(A)-424(Z)(F) if a single temperature threshold were used by the interrupt controller 446 to determine the set of eligible CPU cores 424(0)(1)-424(0)(6)-424(Z)(A)-424(Z)(F) to receive the interrupt 200F.

Also, as discussed below in more detail, because the temperature of the CPU cores 424(0)(1)-424(0)(6)-424(Z)(A)-424(Z)(F) can be highly affected by the temperature of a neighboring CPU core 424(0)(1)-424(0)(6)-424(Z)(A)-424(Z)(F) and/or in the same CPU core cluster 400(0)-400(Z), the interrupt controller 446 can also be configured to determine the set of eligible CPU core(s) 424(0)(1)-424(0)(6)-424(Z)(A)-424(Z)(F) to route an interrupt 200F based not only on a intended eligible CPU core(s) 424(0)(1)-424(0)(6)-424(Z)(A)-424(Z)(F) remaining below its thermal limit to handle the interrupt 200, but also other surrounding CPU cores 424(0)(1)-424(0)(6)-424(Z)(A)-424(Z)(F)(e.g., in close proximity and/or in the same CPU core cluster 400(0)-400(Z)) being determined to remaining below their thermal limits. In this regard, the thermal registers 416(1)-416(F) can also each include an immediate neighbor core field 516 configured store the identity of the CPU cores 424(0)(1)-424(0)(6)-424(Z)(A)-424(Z)(F) that are immediately surrounding the CPU core 424(0)(1)-424(0)(6)-424(Z)(A)-424(Z)(F) for the respective thermal register 416(1)-416(F). The thermal registers 416(1)-416(F) can also each include a distance neighbor core field 518 configured store the identity of the CPU cores 424(0)(1)-424(0)(6)-424(Z)(A)-424(Z)(F) that are surrounding, but not immediately surrounding, the CPU core 424(0)(1)-424(0)(6)-424(Z)(A)-424(Z)(F) for the respective thermal register 416(1)-416(F).

In this manner, the interrupt controller 446 can use this thermal information to guard surrounding CPU cores 424(0)(1)-424(0)(6)-424(Z)(A)-424(Z)(F) from exceeding their thermal limits that may result in directing an interrupt 200F to an eligible CPU core 424(0)(1)-424(0)(6)-424(Z)(A)-424(Z)(F). In other words, if a surrounding CPU core 424(0)(1)-424(0)(6)-424(Z)(A)-424(Z)(F) would exceed its thermal limits based on a surrounding eligible CPU core 424(0)(1)-424(0)(6)-424(Z)(A)-424(Z)(F) handling the interrupt 200F, the interrupt controller 446 could exclude such eligible CPU core 424(0)(1)-424(0)(6)-424(Z)(A)-424(Z)(F) from the set of eligible CPU cores 424(0)(1)-424(0)(6)-424(Z)(A)-424(Z)(F) to route the interrupt 200F. In another example, the interrupt controller 446 can use this thermal information in to determine the temperature effect on an eligible CPU core 424(0)(1)-424(0)(6)-424(Z)(A)-424(Z)(F) handling an interrupt 200F as impacted from the temperature of other surrounding CPU cores 424(0)(1)-424(0)(6)-424(Z)(A)-424(Z)(F). In other words, if an eligible CPU core 424(0)(1)-424(0)(6)-424(Z)(A)-424(Z)(F) would exceed its thermal limits handling the interrupt 200F based on the existing thermal condition and temperature of a surrounding CPU core 424(0)(1)-424(0)(6)-424(Z)(A)-424(Z)(F), the interrupt controller 446 could exclude such eligible CPU core 424(0)(1)-424(0)(6)-424(Z)(A)-424(Z)(F) from the set of eligible CPU cores 424(0)(1)-424(0)(6)-424(Z)(A)-424(Z)(F) to route the interrupt 200F.

In another example, the interrupt controller 446 can be also configured to route interrupts 200F to an eligible CPU core(s) 424(0)(1)-424(0)(6)-424(Z)(A)-424(Z)(F) and/or a CPU core cluster(s) 400(0)-400(Z) that would not cause the overall thermal limit for the processor 404 and/or its processor-based system to be exceeded.

In this regard, as illustrated in FIG. 5, in a first example, the interrupt controller 446 can correlate the received temperature data 212(1)-212(Z) to a temperature for a given eligible CPU core 424(0)(1)-424(0)(6)-424(Z)(A)-424(Z)(F). The interrupt controller 446 can compare the correlated temperature to the maximum temperature threshold stored in the global temperature threshold field 514 in the respective thermal register 416(1)-416(F) for the eligible CPU core 424(0)(1)-424(0)(6)-424(Z)(A)-424(Z)(F). The interrupt controller 446 can be configured to determine if the temperature of the eligible CPU core 424(0)(1)-424(0)(6)-424(Z)(A)-424(Z)(F) exceeds the maximum temperature threshold stored in the respective global temperature threshold field 514. If so, the interrupt controller 446 can exclude the eligible CPU core 424(0)(1)-424(0)(6)-424(Z)(A)-424(Z)(F) from the set of eligible CPU cores 424(0)(1)-424(0)(6)-424 (Z)(A)-424(Z)(F) to receive the interrupt 200F.

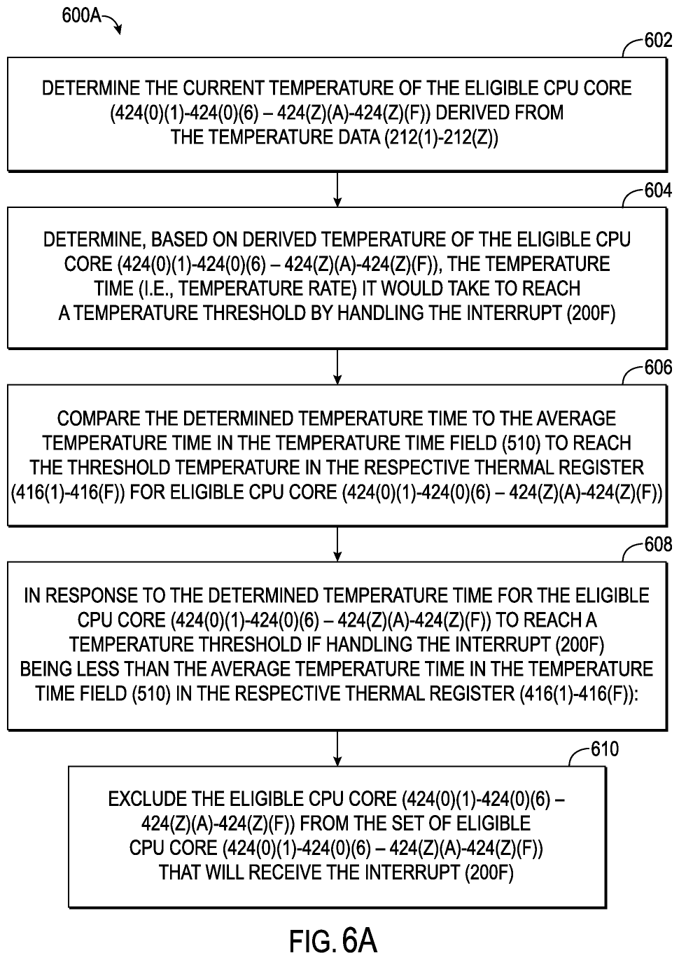

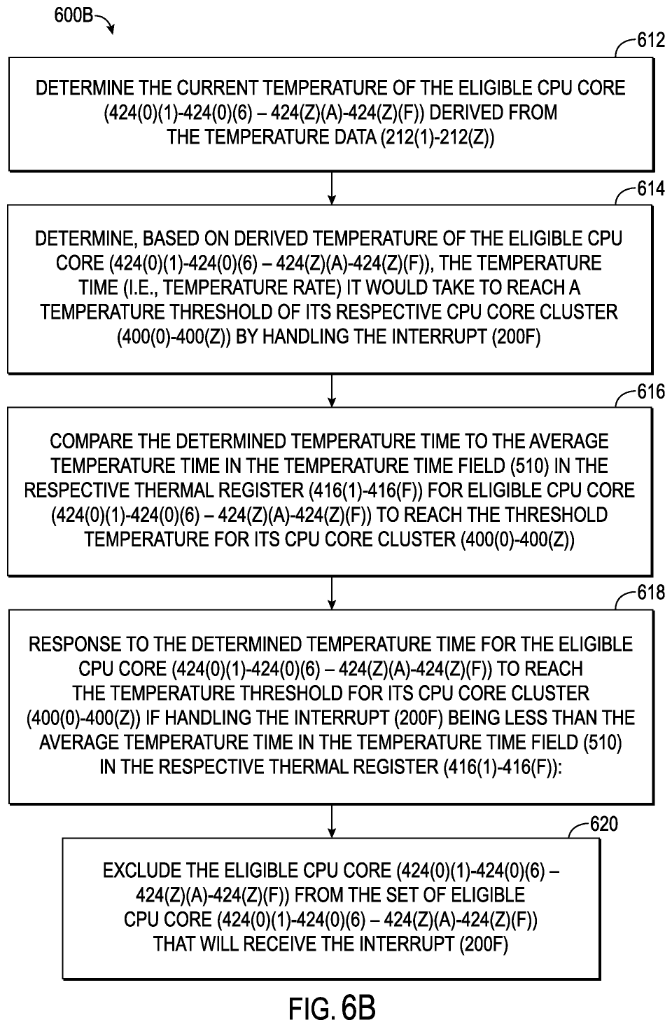

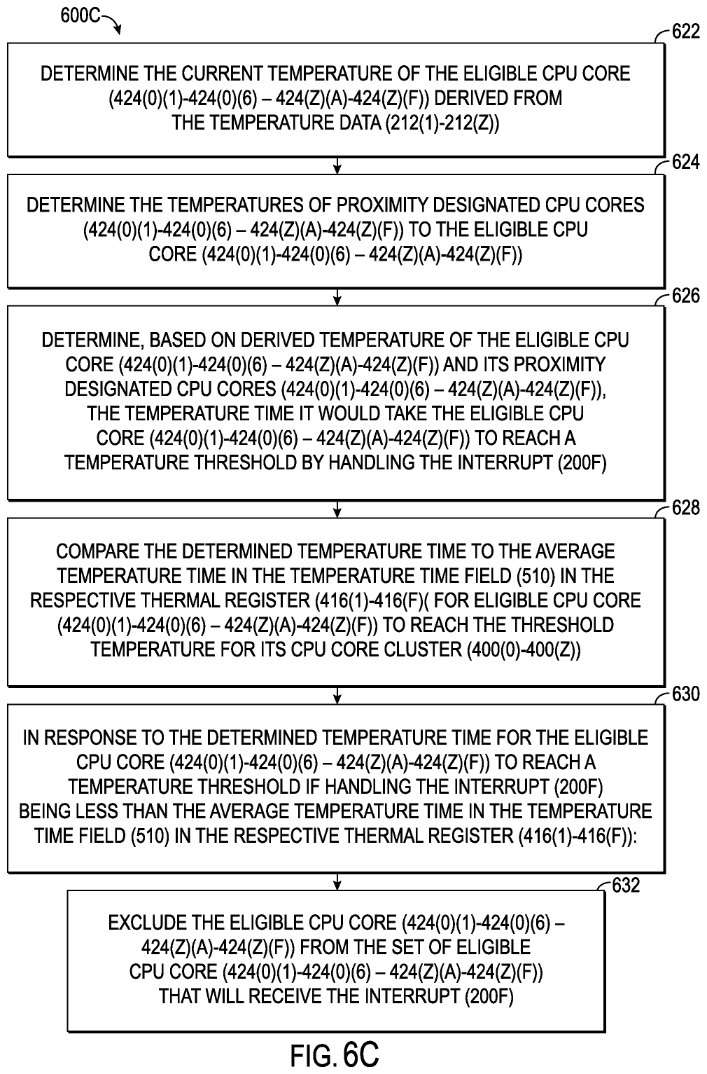

In another example, the interrupt controller 446 can be configured to determine, based on a current temperature from the temperature data 212(0)-212(Z), if a respective eligible CPU core 424(0)(1)-424(0)(6)-424(Z)(A)-424(Z)(F) would exceed a temperate threshold if handling the interrupt 200F based on its temperature time. The interrupt controller 446 can use either the global or individual maximum temperature thresholds stored in the respective global temperature threshold field 514 or the individual temperature threshold field 508 of the respective thermal register 416(1)-416(F). This is shown by example in the process 600A in FIG. 6A that can be performed by either of the interrupt controllers 146, 446 in FIGS. 1-2 and 4. In this regard, using the interrupt controller 446 as an example, the interrupt controller 446 can be configured determine the current temperature of the eligible CPU core 424(0)(1)-424(0)(6)-424(Z)(A)-424(Z)(F) derived from the temperature data 212(1)-212(Z)(block 602 in FIG. 6A). The interrupt controller 446 can then determine, based on the derived temperature of the eligible CPU core 424(0)(1)-424(0)(6)-424(Z)(A)-424(Z)(F), the temperature time (i.e., temperature rate) it would take to reach a temperature threshold by handling the interrupt 200F (block 604 in FIG. 6A). The interrupt controller 446 can compare the determined temperature time to the average temperature time in the temperature time field 510 to reach the threshold temperature in the respective thermal register 416(1)-416(F) for eligible CPU core 424(0)(1)-424(0)(6)-424(Z)(A)-424(Z)(F)(block 606 in FIG. 6A). In response to the determined temperature time for the eligible CPU core 424(0)(1)-424(0)(6)-424(Z)(A)-424(Z)(F) to reach the temperature threshold if handling the interrupt 200F being less than the average temperature time in the temperature time field 510 in the respective thermal register 416(1)-416(F)(block 608 in FIG. 6A), the interrupt controller 446 can exclude the eligible CPU core 424(0)(1)-424(0)(6)-424(Z)(A)-424(Z)(F) from the set of eligible CPU cores 424(0)(1)-424(0)(6)-424(Z)(A)-424(Z)(F) that will receive the interrupt 200F (block 610 in FIG. 6A).

In another example, it may be desired to only route interrupts 200F to eligible CPU cores 424(0)(1)-424(0)(6)-424(Z)(A)-424(Z)(F) that would not cause its respective CPU core cluster 400(0)-400(Z) to exceed a temperature threshold. Limiting interrupt handling to an eligible CPU core 424(0)(1)-424(0)(6)-424(Z)(A)-424(Z)(F) based on the thermal limit of its CPU core cluster 400(0)-400(Z) may be advantageous, because if thermal mitigation is required, the thermal mitigation may reduce the performance of all the CPU cores 424(0)(1)-424(0)(6)-424(Z)(A)-424(Z)(F) in the respective CPU core cluster 400(0)-400(Z) based on the CPU core cluster sharing resources, such as being clocked off a common clock signal.

In this regard, FIG. 6B is a flowchart illustrating an exemplary process 600B that can be performed by the interrupt controllers 146, 446 in FIGS. 1-2 and 4 to route interrupts 200F to only those eligible CPU cores 424(0)(1)-424(0)(6)-424(Z)(A)-424(Z)(F) whose handling of the interrupt 200F would not cause its respective CPU core cluster 400(0)-400(Z) to exceed its temperature threshold. The process 600B is discussed with regard to the interrupt controller 446 as an example, but the process 600B is also applicable to the interrupt controller 146 in FIGS. 1 and 2.

In this regard, with reference to FIG. 6B and using the interrupt controller 446 as an example, the interrupt controller 446 can be configured determine the current temperature of the eligible CPU core 424(0)(1)-424(0)(6)-424(Z)(A)-424(Z)(F) derived from the temperature data 212(1)-212(Z)(block 612 in FIG. 6B). The interrupt controller 446 can then determine, based on the derived temperature of the eligible CPU core 424(0)(1)-424(0)(6)-424(Z)(A)-424(Z)(F), the temperature time (i.e., temperature rate) it would take to reach a temperature threshold of its respective CPU core cluster 400(0)-400(Z) by handling the interrupt 200F (block 614 in FIG. 6B). The temperature threshold of the respective CPU core cluster 400(0)-400(Z) of the eligible CPU core 424(0)(1)-424(0)(6)-424(Z)(A)-424(Z)(F) may be the global temperature threshold in the thermal register 416(1)-416(F) or the highest of the individual temperature thresholds in the respective thermal register 416(1)-416(F), as examples. The interrupt controller 446 can compare the determined temperature time to the average temperature time in the temperature time field 510 in the respective thermal register 416(1)-416(F) for the eligible CPU core 424(0)(1)-424(0)(6)-424(Z)(A)-424(Z)(F) to reach the threshold temperature for its CPU core cluster 400(0)-400(Z)(block 616 in FIG. 6B). In response to the determined temperature time for the eligible CPU core 424(0)(1)-424(0)(6)-424(Z)(A)-424(Z)(F) to reach the temperature threshold for its CPU core cluster 400(0)-400(Z) if handling the interrupt 200F being less than the average temperature time in the temperature time field 510 in the respective thermal register 416(1)-416(F)(block 618 in FIG. 6B), the interrupt controller 446 can exclude the eligible CPU core 424(0)(1)-424(0)(6)-424(Z)(A)-424(Z)(F) from the set of eligible CPU cores 424(0)(1)-424(0)(6)-424(Z)(A)-424(Z)(F) that will receive the interrupt 200F (block 620 in FIG. 6B).

In another example, it may be desired to only route interrupts 200F to eligible CPU cores 424(0)(1)-424(0)(6)-424(Z)(A)-424(Z)(F) that would not exceed a temperature threshold based not only on its temperature, but the temperature of other surrounding CPU cores 0)(1)-424(0)(6)-424(Z)(A)-424(Z)(F) in a designated proximity. For example, the CPU cores 424(0)(1)-424(0)(6)-424(Z)(A)-424(Z)(F) that are within a designated proximity to a given CPU core, the identities of the CPU cores 424(0)(1)-424(0)(6)-424(Z)(A)-424(Z)(F) can be noted and stored in the intermediate neighbor core field 516 of a respective thermal register 416(1)-416(F) for each given CPU core 424(0)(1)-422(0)(6)-422(Z)(A)-422(Z)(F), as described above with regard to FIG. 4 as an example, for access by the interrupt controllers 146, 446. The identities of the CPU cores 424(0)(1)-424(0)(6)-424(Z)(A)-424(Z)(F) that are within a designated proximity to a given CPU core 424(0)(1)-424(0)(6)-424(Z)(A)-424(Z)(F) can also be noted and stored in the intermediate neighbor core field 516 of a respective thermal register 416(1)-416(F) for each given CPU core 424(0)(1)-424(0)(6)-424(Z)(A)-424(Z)(F), as described above with regard to FIG. 4 as an example, for access by the interrupt controllers 146, 446.

In this regard, FIG. 6C is a flowchart illustrating an exemplary process 600C that can be performed by the interrupt controllers 146, 446 in FIGS. 1-2 and 4 to route interrupts 200F to only those eligible CPU cores 424(0)(1)-424(0)(6)-424(Z)(A)-424(Z)(F) whose handling of the interrupt 200F would not cause it to exceed its temperature threshold based on its current temperature and the temperature of other proximity designated CPU cores 424(0)(1)-424(0)(6)-424(Z)(A)-424(Z)(F). The process 600C is discussed with regard to the interrupt controller 446 as an example, but the process 600C is also applicable to the interrupt controller 146 in FIGS. 1 and 2.

In this regard, with reference to FIG. 6C and using the interrupt controller 446 as an example, the interrupt controller 446 can be configured determine the current temperature of the eligible CPU core 424(0)(1)-424(0)(6)-424(Z)(A)-424(Z)(F) derived from the temperature data 212(1)-212(Z)(block 622 in FIG. 6C). The interrupt controller 446 can also be configured determine the temperatures of proximity designated CPU cores 424(0)(1)-424(0)(6)-424(Z)(A)-424(Z)(F) to the eligible CPU core 424(0)(1)-424(0)(6)-424(Z)(A)-424(Z)(F)(block 624 in FIG. 6C). The interrupt controller 446 can then determine, based on the derived temperature of the eligible CPU core 424(0)(1)-424(0)(6)-424(Z)(A)-424(Z)(F) and its proximity designated CPU cores 424(0)(1)-424(0)(6)-424(Z)(A)-424(Z)(F), the temperature time (i.e., temperature rate) it would take the eligible CPU core 424(0)(1)-424(0)(6)-424(Z)(A)-424(Z)(F) to reach a temperature threshold by handling the interrupt 200F (block 626 in FIG. 6C). The interrupt controller 446 can compare the determined temperature time to the average temperature time in the temperature time field 510 in the respective thermal register 416(1)-416(F) for the eligible CPU core 424(0)(1)-424(0)(6)-424(Z)(A)-424(Z)(F) to reach the threshold temperature for its CPU core cluster 400(0)-400(Z)(block 628 in FIG. 6C). In response to the determined temperature time for the eligible CPU core 424(0)(1)-424(0)(6)-424(Z)(A)-424(Z)(F) to reach the temperature threshold if handling the interrupt 200F being less than the average temperature time in the temperature time field 510 in the respective thermal register 416(1)-416(F)(block 630 in FIG. 6C), the interrupt controller 446 can exclude the eligible CPU core 424(0)(1)-424(0)(6)-424(Z)(A)-424(Z)(F) from the set of eligible CPU cores 424(0)(1)-424(0)(6)-424(Z)(A)-424(Z)(F) that will receive the interrupt 200F (block 632 in FIG. 6C).

Note that the interrupt controller 446 can also be configured to determine if an eligible CPU core 424(0)(1)-424(0)(6)-424(Z)(A)-424(Z)(F) will reach the temperature threshold for its CPU core cluster 400(0)-400(Z) if handling the interrupt 200F based on other factors, such as the temperature of its CPU core cluster 400(0)-400(Z) and the proximity of other CPU core clusters 400(0)-400(Z) as other examples.

A processor-based system that includes one or more processors and one or more interrupt controllers including, but not limited to, the interrupt controllers 146, 446 in FIGS. 1-2 and 4, designated for a processor and configured to receive temperature data for CPU cores in a processor and selectively route received interrupts based on routing control information to determine an eligible CPU core(s) to handle the received interrupt and based on the temperature threshold of the eligible CPU core(s) and/or their CPU core cluster as compared to their temperatures, and according to, but not limited to, the processes 300, 600A-600C in FIGS. 3 and 6A-6C, and according to any aspects disclosed herein, may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, an avionics system, a drone, and a multicopter.

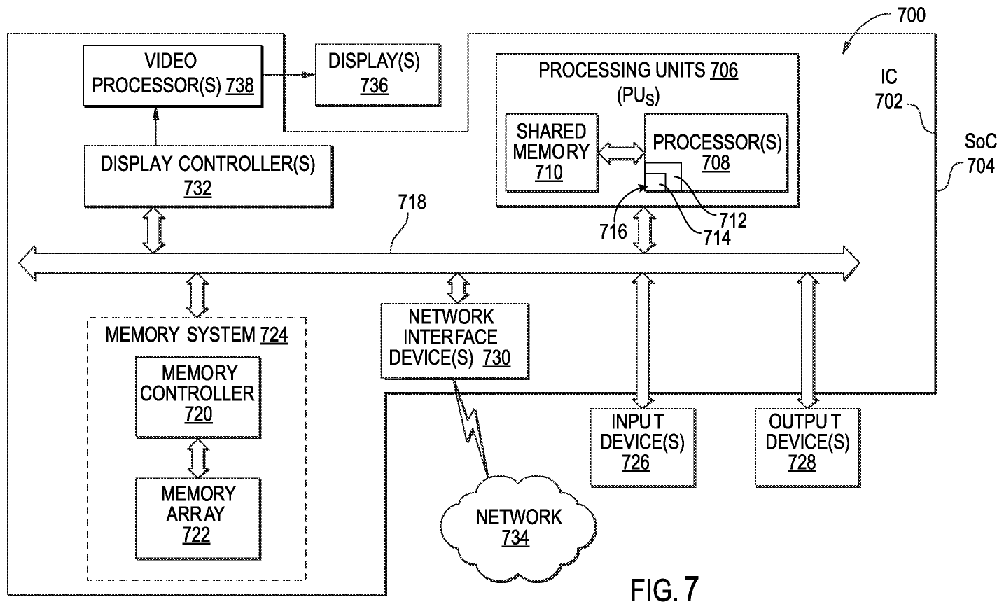

In this regard, FIG. 7 illustrates an example of a processor-based system 700. In this example, the processor-based system 700 may be formed as an IC 702 and as a system-on-a-chip (SoC) 704. The processor-based system 700 includes PUs 706 that include one or more processors 708, which can include a CPU, GPU, and NPU as examples, like the CPUs 114, 116, the GPU 118, and NPU 120 in the processor-based system 100 in FIGS. 1-2. The PUs 706 may have a shared memory 710 (e.g., a shared cache memory) coupled to the PUs 706 for rapid access to temporarily stored data. Some or all of the processors 708 may include an interrupt controller 712 like the interrupt controllers 146, 446 in FIGS. 1-2 and 4, designated for a processor 708 and configured to receive temperature data for CPU cores in the processor and selectively route received interrupts based on routing control information to determine an eligible CPU core(s) to handle the received interrupt and based on the temperature threshold of the eligible CPU core(s) and/or their CPU core cluster as compared to their temperatures, and according to, but not limited to, the processes 300, 600A-600C in FIGS. 3 and 6A-6C. Each interrupt controller 712 may contain a computer-readable medium 714 that is configured to store computer instructions 716 to be executed to perform some or all of the functions of the interrupt controller 712. Note that the interrupt controller 712 can be configured to route interrupts for one dedicated processor 708 or be shared to route interrupts to multiple processors 708.

The processors 708 are coupled to a system bus 718 and can intercouple master and slave devices included in the processor-based system 700. As is well known, the processors 708 communicate with these other devices by exchanging address, control, and data information over the system bus 718. For example, the processors 708 can communicate bus transaction requests to a memory controller 720, as an example of a slave device. Although not illustrated in FIG. 7, multiple system buses 718 could be provided, wherein each system bus 718 constitutes a different fabric.

Other master and slave devices can be connected to the system bus 718. As illustrated in FIG. 7, these devices can include a memory system 724 that includes the memory controller 720 and a memory array(s) 722, one or more input devices 726, one or more output devices 728, one or more network interface devices 730, and one or more display controllers 732 as examples. The input device(s) 726 can include any type of input device, including, but not limited to, input keys, switches, voice processors, etc. The output device(s) 728 can include any type of output device, including, but not limited to, audio, video, other visual indicators, etc. The network interface device(s) 730 can be any device configured to allow exchange of data to and from a network 734. The network 734 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 730 can be configured to support any type of communications protocol desired.

The processors 708 may also be configured to access the display controller(s) 732 over the system bus 718 to control information sent to one or more displays 736. The display controller(s) 732 sends information to the display(s) 736 to be displayed via one or more video processors 738, which process the information to be displayed into a format suitable for the display(s) 736. The display controller(s) 732 and video processor(s) 738 can be included in the same or different ICs, or in the same IC 702 containing the processors 708, as examples. The display(s) 736 can include any type of display, including, but not limited to, a cathode ray tube (CRT), a liquid crystal display (LCD), a plasma display, a light emitting diode (LED) display, etc.

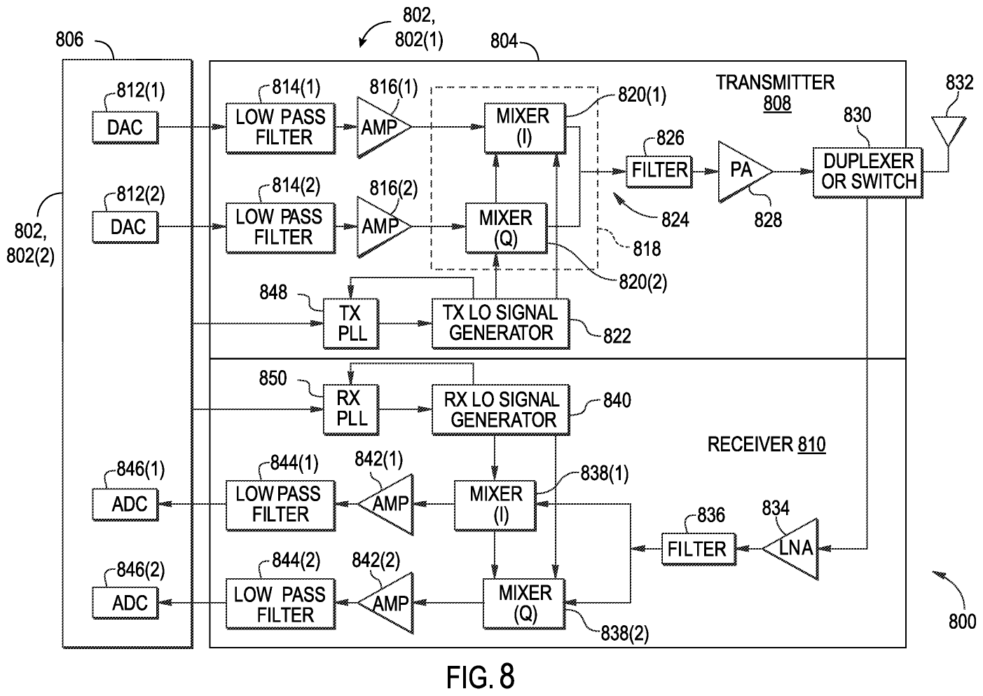

FIG. 8 illustrates an exemplary wireless communications device 800 that includes radio frequency (RF) components and that can include a processor-based system 802 that includes one or more processors and one or more interrupt controllers including, but not limited to, the interrupt controllers 146, 446 in FIGS. 1-2 and 4, designated for a processor and configured to receive temperature data for CPU cores in a processor and selectively route received interrupts based on routing control information to determine an eligible CPU core(s) to handle the received interrupt and based on the temperature threshold of the eligible CPU core(s) and/or their CPU core cluster as compared to their temperatures, and according to, but not limited to, the processes 300, 600A-600C in FIGS. 3 and 6A-6C, and according to any aspects disclosed herein. The wireless communications device 800 may include or be provided in any of the above-referenced devices, as examples.

As shown in FIG. 8, the wireless communications device 800 includes a transceiver 804 and a data processor 806, each of which may include its processor-based system 802(1), 802(2). The data processor 806 may include a memory to store data and program codes. The transceiver 804 includes a transmitter 808 and a receiver 810 that support bi-directional communications. In general, the wireless communications device 800 may include any number of transmitters 808 and/or receivers 810 for any number of communication systems and frequency bands. All or a portion of the transceiver 804 may be implemented on one or more analog ICs, RF ICs (RFICs), mixed-signal ICs, etc.

The transmitter 808 or the receiver 810 may be implemented with a super-heterodyne architecture or a direct-conversion architecture. In the super-heterodyne architecture, a signal is frequency-converted between RF and baseband in multiple stages, e.g., from RF to an intermediate frequency (IF) in one stage, and then from IF to baseband in another stage for the receiver 810. In the direct-conversion architecture, a signal is frequency-converted between RF and baseband in one stage. The super-heterodyne and direct-conversion architectures may use different circuit blocks and/or have different requirements. In the wireless communications device 800 in FIG. 8, the transmitter 808 and the receiver 810 are implemented with the direct-conversion architecture.

In the transmit path, the data processor 806 processes data to be transmitted and provides I and Q analog output signals to the transmitter 808. In the exemplary wireless communications device 800, the data processor 806 includes digital-to-analog converters (DACs) 812(1), 812(2) for converting digital signals generated by the data processor 806 into the I and Q analog output signals, e.g., I and Q output currents, for further processing.

Within the transmitter 808, lowpass filters 814(1), 814(2) filter the I and Q analog output signals, respectively, to remove undesired signals caused by the prior digital-to-analog conversion. Amplifiers (AMPs) 816(1), 816(2) amplify the signals from the lowpass filters 814(1), 814(2), respectively, and provide I and Q baseband signals. An upconverter 818 upconverts the I and Q baseband signals with I and Q transmit (TX) local oscillator (LO) signals through mixers 820(1), 820(2) from a TX LO signal generator 822 to provide an upconverted signal 824. A filter 826 filters the upconverted signal 824 to remove undesired signals caused by the frequency up-conversion as well as noise in a receive frequency band. A power amplifier (PA) 828 amplifies the upconverted signal 824 from the filter 826 to obtain the desired output power level and provides a transmit RF signal. The transmit RF signal is routed through a duplexer or switch 830 and transmitted via an antenna 832.

In the receive path, the antenna 832 receives signals transmitted by base stations and provides a received RF signal, which is routed through the duplexer or switch 830 and provided to a low noise amplifier (LNA) 834. The duplexer or switch 830 is designed to operate with a specific receive (RX)-to-TX duplexer frequency separation, such that RX signals are isolated from TX signals. The received RF signal is amplified by the LNA 834 and filtered by a filter 836 to obtain a desired RF input signal. Down-conversion mixers 838(1), 838(2) mix the output of the filter 836 with I and Q RX LO signals (i.e., LO_I and LO_Q) from an RX LO signal generator 840 to generate I and Q baseband signals. The I and Q baseband signals are amplified by AMPs 842(1), 842(2) and further filtered by lowpass filters 844(1), 844(2) to obtain I and Q analog input signals, which are provided to the data processor 806. In this example, the data processor 806 includes analog-to-digital converters (ADCs) 846(1), 846(2) for converting the analog input signals into digital signals to be further processed by the data processor 806.

In the wireless communications device 800 of FIG. 8, the TX LO signal generator 822 generates the I and Q TX LO signals used for frequency up-conversion, while the RX LO signal generator 840 generates the I and Q RX LO signals used for frequency down-conversion. Each LO signal is a periodic signal with a particular fundamental frequency. A TX phase-locked loop (PLL) circuit 848 receives timing information from the data processor 806 and generates a control signal used to adjust the frequency and/or phase of the TX LO signals from the TX LO signal generator 822. Similarly, an RX PLL circuit 850 receives timing information from the data processor 806 and generates a control signal used to adjust the frequency and/or phase of the RX LO signals from the RX LO signal generator 840.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device or processing unit, or combinations of both. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

Implementation examples are described in the following numbered clauses:

1. An interrupt controller in a processor-based system, the interrupt controller configured to:
receive temperature data related to a temperature for a plurality of central processing units (CPU) cores in a processor in the processor-based system;
receive an interrupt in the processor-based system;
determine one or more eligible CPU cores of the plurality of CPU cores eligible to handle the interrupt based on an interrupt routing policy;
determine, based on the temperature data, a first set of eligible CPU cores of the one or more eligible CPU cores that would remain below a temperature
threshold based on handling the interrupt; and communicate the interrupt to be received by the first set of eligible CPU cores.
   2. The interrupt controller of clause 1 further configured to not communicate the interrupt to the plurality of CPU cores not included in the first set of eligible CPU cores.
   3. The interrupt controller of clause 1 or 2 configured to receive the temperature data related to the temperature for the plurality of CPU cores in response to receiving the interrupt.
   4. The interrupt controller of clause 1 or 2 configured to continuously receive the temperature data related to the temperature for the plurality of CPU cores in response to receiving the interrupt.
   5. The interrupt controller of any of clauses 1-4 configured to:
receive the temperature data by being configured to:
   receive temperature data related to a temperature for each of the plurality of CPU cores in a processor in the processor-based system; and
determine the first set of eligible CPU cores by being configured to:
   determine, based on the temperature data for each CPU core of the one or more eligible CPU cores, the first set of eligible CPU cores of the one or more eligible CPU cores that would remain below the temperature threshold based on handling the interrupt.
      6. The interrupt controller of any of clauses 1-5 configured to determine the first set of eligible CPU cores by being configured to:
determine, based on the temperature data, the first set eligible CPU cores of the one or more eligible CPU cores that would remain below a global temperature threshold established for the one or more eligible CPU cores based on handling the interrupt.
   7. The interrupt controller of any of clauses 1-5 configured to determine the first set of eligible CPU cores by being configured to:
determine, based on the temperature data, a temperature time for each of the one or more eligible CPU cores to reach the temperature threshold based on handling the interrupt; and
determine, based on the respective temperature time of each of the one or more eligible CPU cores, the first set of eligible CPU cores from the one or more eligible CPU cores that would remain below the temperature threshold based on its respective temperature time.
   8. The interrupt controller of any of clauses 1-5 configured to determine the first set of eligible CPU cores by being configured to:
determine, based on the temperature data, the first set of eligible CPU cores of the one or more eligible CPU cores that would remain below the temperature threshold such that the processor would remain below a global temperature threshold, based on handling the interrupt.
   9. The interrupt controller of any of clauses 1-5 configured to determine the first set of eligible CPU cores, by being configured to:
determine, based on the temperature data, the first set of eligible CPU cores of the one or more eligible CPU cores that would remain below the same temperature threshold based on handling the interrupt.
   10. The interrupt controller of any of clauses 1-5 configured to determine the first set of eligible CPU cores by being configured to:
determine, based on the temperature data, the first set of eligible CPU cores of the one or more eligible CPU cores that would remain below a respective temperature threshold for each of the one or more eligible CPU cores based on handling the interrupt.
   11. The interrupt controller of any of clauses 1-5 configured to determine the one or more eligible CPU cores by being configured to:
determine the one or more eligible CPU cores, based on the temperature data of one or more proximity designated CPU cores to the first set of eligible CPU cores, that would remain below the temperature threshold based on handling the interrupt.
   12. The interrupt controller of any of clauses 1-5 configured to determine the one or more eligible CPU cores by being configured to:
determine, based on the temperature data of one or more proximity designated CPU cores to the first set of eligible CPU cores, the first set of eligible CPU cores, that would cause the one or more proximity designated CPU cores to remain below the temperature threshold based on the first set of eligible CPU cores handling the interrupt.
   13. The interrupt controller of any of clauses 1-5, configured to determine the one or more eligible CPU cores by being configured to:
determine, based on the temperature data of a CPU core cluster containing the first set of eligible CPU cores, the first set of eligible CPU cores that would remain below the temperature threshold of the CPU core cluster based on handling the interrupt.
   14. The interrupt controller of any of clauses 1-13, further comprising:
a temperature capture circuit configured to receive the temperature data related to the temperature for the plurality of CPU cores in the processor in the processor-based system; and
a temperature-aware routing circuit configured to:
   determine, based on the temperature data, the first set of eligible CPU cores of the one or more eligible CPU cores that would remain below the temperature threshold based on handling the interrupt;
   and communicate the interrupt to be received by the first set of eligible CPU cores.
      15. The interrupt controller of any of clauses 1-14, further comprising one or more thermal registers; and
the interrupt controller further configured to:
   receive the temperature threshold; and
   store the received temperature threshold in the one or more thermal registers;
the interrupt controller configured to determine, based on the temperature data, the first set of eligible CPU cores of the one or more eligible CPU cores that would remain below the temperature threshold based on handling the interrupt by being configured to:
   determine the first set of eligible CPU cores that would remain below the temperature threshold stored in the temperature threshold register.
      16. The interrupt controller of any of clauses 1-15, further comprising a control unit circuit configured to store the temperature threshold for each CPU core of the plurality of CPU cores; and
the interrupt controller configured to determine, based on the temperature data, the first set of eligible CPU cores of the one or more eligible CPU cores that would remain below the respective temperature threshold stored in the control unit circuit for each of the first set of eligible CPU cores, based on handling the interrupt.
   17. The interrupt controller of any of clauses 1-16 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.
   18. A method of routing interrupts to central processing unit (CPU) cores in a processor, comprising:
receiving temperature data related to a temperature for a plurality of CPU cores in a processor in a processor-based system;
receiving an interrupt in the processor-based system;
determining one or more eligible CPU cores of the plurality of CPU cores eligible to handle the interrupt based on an interrupt routing policy;
determining, based on the temperature data, a first set of eligible CPU cores of the one or more eligible CPU cores that would remain below a temperature threshold based on handling the interrupt; and communicating the interrupt to be received by the first set of eligible CPU cores.
   19. The method of clause 18, further comprising not communicating the interrupt to the plurality of CPU cores not included in the first set of eligible CPU cores.
   20. The method of clause 18 or 19, wherein receiving the temperature data comprises receiving the temperature data related to the temperature for the plurality of CPU cores in response to receiving the interrupt.
   21. The method of clause 18 or 19, wherein receiving the temperature data comprises continuously receiving the temperature data related to the temperature for the plurality of CPU cores in response to receiving the interrupt.
   22 The method of clause 18 or 19,
wherein receiving the temperature data comprises:
   receiving the temperature data related to a temperature for each of the plurality of CPU cores in a processor in the processor-based system; and
wherein the first set of eligible CPU cores comprises:
   determining, based on the temperature data for each CPU core of the one or more eligible CPU cores, the first set of eligible CPU cores of the one or more eligible CPU cores that would remain below the temperature threshold based on handling the interrupt.
      23. The method of any of clauses 18-22, wherein determining the first set of eligible CPU cores comprises:
determining, based on the temperature data, the first set eligible CPU cores of the one or more eligible CPU cores that would remain below a global temperature threshold established for the one or more eligible CPU cores based on handling the interrupt.
   24. The method of any of clauses 18-22, wherein determining the first set of eligible CPU cores comprises:
determining, based on the temperature data, a temperature time for each of the one or more eligible CPU cores to reach the temperature threshold based on handling the interrupt; and
determining, based on the respective temperature time of each of the one or more eligible CPU cores, the first set of eligible CPU cores from the one or more eligible CPU cores that would remain below the temperature threshold based on its respective temperature time.
   25. The method of any of clauses 18-22, wherein determining the first set of eligible CPU cores comprises:
determining, based on the temperature data, the first set of eligible CPU cores of the one or more eligible CPU cores that would remain below a respective temperature threshold for each of the one or more eligible CPU cores based on handling the interrupt.
   26. The method of any of clauses 18-22, wherein determining the first set of eligible CPU cores comprises:
determining, based on the temperature data of one or more proximity designated CPU cores to the first set of eligible CPU cores, the first set of eligible CPU cores that would remain below the temperature threshold based on handling the interrupt.
   27. The method of any of clauses 18-22, wherein determining the first set of eligible CPU cores comprises:
determining, based on the temperature data of a CPU core cluster containing the first set of eligible CPU cores, a first set of eligible CPU cores from the first set of eligible CPU cores that would remain below the temperature threshold of the CPU core cluster based on handling the interrupt.
   28. A processor-based system, comprising:
a plurality of interrupt generating devices each configured to generate an interrupt;
a first processor comprising a plurality of first central processing unit (CPU) cores; and
a first interrupt controller configured to:
   receive first temperature data related to a temperature for the plurality of first CPU cores from one or more temperature sensors;
   receive a first interrupt from an interrupt generating device of the plurality of interrupt generating devices;
   determine one or more first eligible CPU cores of the plurality of first CPU cores eligible to handle the first interrupt based on a first interrupt routing policy;
   determine, based on the first temperature data, a first set of eligible CPU cores of the one or more first eligible CPU cores that would remain below a first temperature threshold based on handling the first interrupt; and
   communicate the first interrupt to be received by the first set of eligible CPU cores; and
each first eligible CPU core of the first set of eligible CPU cores configured to: receive the first interrupt;
   determine whether to service the first interrupt; and
   in response to determining to service the first interrupt, service the first interrupt.
      29. The processor-based system of clause 28, further comprising:
a second processor comprising a plurality of second CPU cores; and
a second interrupt controller configured to:
   receive second temperature data related to a temperature for the plurality of second CPU cores;
   receive a second interrupt from an interrupt generating device of the plurality of interrupt generating devices;
   determine one or more second eligible CPU cores of the plurality of second CPU cores eligible to handle the second interrupt based on a second interrupt routing policy;
   determine, based on the second temperature data, a second set of eligible CPU cores of the one or more second eligible CPU cores that would remain below a second temperature threshold based on handling the second interrupt; and
   communicate the second interrupt to be received by the second set of eligible CPU cores; and
each second eligible CPU core of the second set of eligible CPU cores configured to:
   receive the second interrupt; and
   in response to determining to service the second interrupt, service the second interrupt.
      30. The processor-based system of clause 28, further comprising a second processor, comprising a plurality of second CPU cores;
the first interrupt controller configured to:
   receive second temperature data related to a temperature for the plurality of second CPU cores;
   receive a second interrupt from an interrupt generating device of the plurality of interrupt generating devices;
   determine one or more second eligible CPU cores of the plurality of second CPU cores eligible to handle the second interrupt based on a second interrupt routing policy;
   determine, based on the second temperature data, a second set of eligible CPU cores of the one or more second eligible CPU cores that would remain below a second temperature threshold based on handling the second interrupt; and
   communicate the second interrupt to be received by the second set of eligible CPU cores; and
each second eligible CPU core of the second set of eligible CPU cores configured to:
   receive the second interrupt; and
   in response to determining to service the second interrupt, service the second interrupt.

What is claimed is:

1. An interrupt controller in a processor-based system, the interrupt controller configured to:
receive temperature data related to a temperature for a plurality of central processing units (CPU) cores in a processor in the processor-based system;
receive an interrupt in the processor-based system;
determine one or more eligible CPU cores of the plurality of CPU cores eligible to handle the interrupt based on an interrupt routing policy;
determine, based on the temperature data, a first set of eligible CPU cores of the one or more eligible CPU cores that would remain below a temperature threshold based on handling the interrupt; and
communicate the interrupt to be received by the first set of eligible CPU cores.

2. The interrupt controller of claim 1, further configured to not communicate the interrupt to the plurality of CPU cores not included in the first set of eligible CPU cores.

3. The interrupt controller of claim 1, configured to receive the temperature data related to the temperature for the plurality of CPU cores in response to receiving the interrupt.

4. The interrupt controller of claim 1, configured to continuously receive the temperature data related to the temperature for the plurality of CPU cores in response to receiving the interrupt.

5. The interrupt controller of claim 1, configured to:
receive the temperature data by being configured to:
receive temperature data related to a temperature for each of the plurality of CPU cores in a processor in the processor-based system; and
determine the first set of eligible CPU cores by being configured to:
determine, based on the temperature data for each CPU core of the one or more eligible CPU cores, the first set of eligible CPU cores of the one or more eligible CPU cores that would remain below the temperature threshold based on handling the interrupt.

6. The interrupt controller of claim 1, configured to determine the first set of eligible CPU cores by being configured to:
determine, based on the temperature data, the first set eligible CPU cores of the one or more eligible CPU cores that would remain below a global temperature threshold established for the one or more eligible CPU cores based on handling the interrupt.

7. The interrupt controller of claim 1, configured to determine the first set of eligible CPU cores by being configured to:
determine, based on the temperature data, a temperature time for each of the one or more eligible CPU cores to reach the temperature threshold based on handling the interrupt; and
determine, based on the respective temperature time of each of the one or more eligible CPU cores, the first set of eligible CPU cores from the one or more eligible CPU cores that would remain below the temperature threshold based on its respective temperature time.

8. The interrupt controller of claim 1, configured to determine the first set of eligible CPU cores by being configured to:
determine, based on the temperature data, the first set of eligible CPU cores of the one or more eligible CPU cores that would remain below the temperature threshold such that the processor would remain below a global temperature threshold, based on handling the interrupt.

9. The interrupt controller of claim 1, configured to determine the first set of eligible CPU cores, by being configured to:
determine, based on the temperature data, the first set of eligible CPU cores of the one or more eligible CPU cores that would remain below the same temperature threshold based on handling the interrupt.

10. The interrupt controller of claim 1, configured to determine the first set of eligible CPU cores by being configured to:
determine, based on the temperature data, the first set of eligible CPU cores of the one or more eligible CPU cores that would remain below a respective temperature threshold for each of the one or more eligible CPU cores based on handling the interrupt.

11. The interrupt controller of claim 1, configured to determine the one or more eligible CPU cores by being configured to:
determine the one or more eligible CPU cores, based on the temperature data of one or more proximity designated CPU cores to the first set of eligible CPU cores, that would remain below the temperature threshold based on handling the interrupt.

12. The interrupt controller of claim 1, configured to determine the one or more eligible CPU cores by being configured to:
determine, based on the temperature data of one or more proximity designated CPU cores to the first set of eligible CPU cores, the first set of eligible CPU cores, that would cause the one or more proximity designated CPU cores to remain below the temperature threshold based on the first set of eligible CPU cores handling the interrupt.

13. The interrupt controller of claim 1, configured to determine the one or more eligible CPU cores by being configured to:
determine, based on the temperature data of a CPU core cluster containing the first set of eligible CPU cores, the first set of eligible CPU cores that would remain below the temperature threshold of the CPU core cluster based on handling the interrupt.

14. The interrupt controller of claim 1, further comprising:
a temperature capture circuit configured to receive the temperature data related to the temperature for the plurality of CPU cores in the processor in the processor-based system; and
a temperature-aware routing circuit configured to:
determine, based on the temperature data, the first set of eligible CPU cores of the one or more eligible CPU cores that would remain below the temperature threshold based on handling the interrupt; and
communicate the interrupt to be received by the first set of eligible CPU cores.

15. The interrupt controller of claim 1, further comprising one or more thermal registers; and
the interrupt controller further configured to:
receive the temperature threshold; and
store the received temperature threshold in the one or more thermal registers;
the interrupt controller configured to determine, based on the temperature data, the first set of eligible CPU cores of the one or more eligible CPU cores that would remain below the temperature threshold based on handling the interrupt by being configured to:
determine the first set of eligible CPU cores that would remain below the temperature threshold stored in the temperature threshold register.

16. The interrupt controller of claim 1, further comprising a control unit circuit configured to store the temperature threshold for each CPU core of the plurality of CPU cores; and
the interrupt controller configured to determine, based on the temperature data, the first set of eligible CPU cores of the one or more eligible CPU cores that would remain below the respective temperature threshold stored in the control unit circuit for each of the first set of eligible CPU cores, based on handling the interrupt.

17. The interrupt controller of claim 1 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

18. A method of routing interrupts to central processing unit (CPU) cores in a processor, comprising:
receiving temperature data related to a temperature for a plurality of CPU cores in a processor in a processor-based system;
receiving an interrupt in the processor-based system;
determining one or more eligible CPU cores of the plurality of CPU cores eligible to handle the interrupt based on an interrupt routing policy;
determining, based on the temperature data, a first set of eligible CPU cores of the one or more eligible CPU cores that would remain below a temperature threshold based on handling the interrupt; and
communicating the interrupt to be received by the first set of eligible CPU cores.

19. The method of claim 18, further comprising not communicating the interrupt to the plurality of CPU cores not included in the first set of eligible CPU cores.

20. The method of claim 18, wherein receiving the temperature data comprises receiving the temperature data related to the temperature for the plurality of CPU cores in response to receiving the interrupt.

21. The method of claim 18, wherein receiving the temperature data comprises continuously receiving the temperature data related to the temperature for the plurality of CPU cores in response to receiving the interrupt.

22. The method of claim 18,
wherein receiving the temperature data comprises:
receiving the temperature data related to a temperature for each of the plurality of CPU cores in a processor in the processor-based system; and
wherein the first set of eligible CPU cores comprises:
determining, based on the temperature data for each CPU core of the one or more eligible CPU cores, the first set of eligible CPU cores of the one or more eligible CPU cores that would remain below the temperature threshold based on handling the interrupt.

23. The method of claim 18, wherein determining the first set of eligible CPU cores comprises:
determining, based on the temperature data, the first set eligible CPU cores of the one or more eligible CPU cores that would remain below a global temperature threshold established for the one or more eligible CPU cores based on handling the interrupt.

24. The method of claim 18, wherein determining the first set of eligible CPU cores comprises:
determining, based on the temperature data, a temperature time for each of the one or more eligible CPU cores to reach the temperature threshold based on handling the interrupt; and
determining, based on the respective temperature time of each of the one or more eligible CPU cores, the first set of eligible CPU cores from the one or more eligible CPU cores that would remain below the temperature threshold based on its respective temperature time.

25. The method of claim 18, wherein determining the first set of eligible CPU cores comprises:
determining, based on the temperature data, the first set of eligible CPU cores of the one or more eligible CPU cores that would remain below a respective temperature threshold for each of the one or more eligible CPU cores based on handling the interrupt.

26. The method of claim 18, wherein determining the first set of eligible CPU cores comprises:
determining, based on the temperature data of one or more proximity designated CPU cores to the first set of eligible CPU cores, the first set of eligible CPU cores that would remain below the temperature threshold based on handling the interrupt.

27. The method of claim 18, wherein determining the first set of eligible CPU cores comprises:
determining, based on the temperature data of a CPU core cluster containing the first set of eligible CPU cores, a first set of eligible CPU cores from the first set of eligible CPU cores that would remain below the temperature threshold of the CPU core cluster based on handling the interrupt.

28. A processor-based system, comprising:
a plurality of interrupt generating devices each configured to generate an interrupt;
a first processor comprising a plurality of first central processing unit (CPU) cores; and
a first interrupt controller configured to:
receive first temperature data related to a temperature for the plurality of first CPU cores from one or more temperature sensors;
receive a first interrupt from an interrupt generating device of the plurality of interrupt generating devices;
determine one or more first eligible CPU cores of the plurality of first CPU cores eligible to handle the first interrupt based on a first interrupt routing policy;
determine, based on the first temperature data, a first set of eligible CPU cores of the one or more first eligible CPU cores that would remain below a first temperature threshold based on handling the first interrupt; and
communicate the first interrupt to be received by the first set of eligible CPU cores; and
each first eligible CPU core of the first set of eligible CPU cores configured to:
receive the first interrupt;
determine whether to service the first interrupt; and
in response to determining to service the first interrupt, service the first interrupt.

29. The processor-based system of claim 28, further comprising:
a second processor comprising a plurality of second CPU cores; and
a second interrupt controller configured to:
receive second temperature data related to a temperature for the plurality of second CPU cores;
receive a second interrupt from an interrupt generating device of the plurality of interrupt generating devices;
determine one or more second eligible CPU cores of the plurality of second CPU cores eligible to handle the second interrupt based on a second interrupt routing policy;
determine, based on the second temperature data, a second set of eligible CPU cores of the one or more second eligible CPU cores that would remain below a second temperature threshold based on handling the second interrupt; and
communicate the second interrupt to be received by the second set of eligible CPU cores; and
each second eligible CPU core of the second set of eligible CPU cores configured to:
receive the second interrupt; and
in response to determining to service the second interrupt, service the second interrupt.

30. The processor-based system of claim 28, further comprising a second processor, comprising a plurality of second CPU cores;
the first interrupt controller configured to:
receive second temperature data related to a temperature for the plurality of second CPU cores;
receive a second interrupt from an interrupt generating device of the plurality of interrupt generating devices;
determine one or more second eligible CPU cores of the plurality of second CPU cores eligible to handle the second interrupt based on a second interrupt routing policy;
determine, based on the second temperature data, a second set of eligible CPU cores of the one or more second eligible CPU cores that would remain below a second temperature threshold based on handling the second interrupt; and
communicate the second interrupt to be received by the second set of eligible CPU cores; and
each second eligible CPU core of the second set of eligible CPU cores configured to:
receive the second interrupt; and
in response to determining to service the second interrupt, service the second interrupt.
